(19) United States
(12) Patent Application Publication
(10) Pub. No.: US 2023/0402850 A1
(43) Pub. Date: Dec. 14, 2023

(54) SYSTEMS AND METHODS FOR RESTORATION OF ESSENTIAL SYSTEMS FOR CATASTROPHIC UTILITY EMERGENCY

(71) Applicant: ONCOR ELECTRIC DELIVERYCOMPANY, Dallas, TX (US)

(72) Inventor: Randy Mark BOYS, Allen, TX (US)

(73) Assignee: ONCOR ELECTRIC DELIVERYCOMPANY, Dallas, TX (US)

(21) Appl. No.: 18/317,037

(22) Filed: May 12, 2023

Related U.S. Application Data
(60) Provisional application No. 63/364,696, filed on May 13, 2022.

(51) Int. Cl. H02J 3/38

(52) U.S. Cl. CPC H02J 3/381; H02J 3/388

(57) ABSTRACT

A method of forming an emergency response and continuity of operations (COOP) area-wide grid of microgrids is provided. The method can include: upon an power outage occurring to an Utility power Distribution grid network, identifying one or more nodes having an electric vehicle service equipment (EVSE) power; forming a power microgrid comprising the one or more nodes; activating a communication payload on the one or more nodes; and forming an area-wide grid of microgrids based on the communication payload and the power microgrid.

### CROSS REFERENCE TO RELATED APPLICATION

This application claims a priority of Provisional U.S. Patent Application No. 63/364,696 filed May 13, 2022, the complete disclosure of which is incorporated herein by reference in its entirety.

### FIELD OF THE INVENTION

The present disclosure relates to power Grid management technology, and more particularly, to systems and methods for restoration of essential systems for catastrophic Utility emergency, such as for restoration of continuity of critical Internet of Things (IoT) services as provided by Long Term Evolution (LTE) and beyond. This can be a resource-constrained ‘best available’ reconstruction of IoT services, enabled by the fragments of the power Grid.

### BACKGROUND

When Grid power is lost, or when municipal infrastructure is damaged by catastrophic weather or man-made events, the widely distributed (and only now emerging) 5G Long Term Evolution (LTE) ‘Small Multiple Input Multiple Output (MIMO)’ antenna network required for wireless high bandwidth urban IoT (Internet of Things) connectivity stops working; at the same time, wired IoT access ceases. These 5G assets are increasingly not just ‘desirable’ assets, they are critical infrastructure, initially during emergency response coordination, but also during protracted abnormal conditions for ‘Continuity of Operations’ (COOP), a common disaster recovery term addressing the period during which emphasis changes from emergency response to the provision of core civic and life-sustaining commercial services (e.g., food/water, waste/transportation/health services, etc.), during prolonged Grid outages. During such periods, the loss of LTE impacts traffic management (and, in the near future, intelligent highways and vehicle systems), emergency communications cannot be serviced (or must fall back upon 1970s technologies), sensing of local hazards or needed EMT response does not occur, public notices cannot be issued, and the overall framework for COOP is slowed by required manual processes, etc.

Large 4G nodes sometimes have a local source of emergency power, although only for brief periods. Today, and particularly in urban settings, there is a very good chance that a given cellphone or other IoT-connected device is within service range of multiple antennas, given that they may be more than a mile apart. And, that spacing is for each service provider; a device can ‘roam’ to another service provider if their own is not present, again increasing the likelihood of coverage. Furthermore, this large spacing maps on to the Utility grid in a manner that almost ensures that two service provider 4G antennae/base stations will not be on the same segment of a Distribution feeder, if on the same Distribution-forming substation transformer bank, or Transmission substation. Given that the bulk of Utility power outages are somewhere along a feeder at the Distribution level and not Substation or bulk Grid (i.e., energy availability from the Transmission system) and the aforementioned spacing and roaming ‘redundancy’, today's cellular clients are unaware of the preponderance of outages as they may impact specific service provider assets. That is, a client's house or business may be out of power, but the client's cell phone most likely is not. This resilience, however, would not be present in a widespread outage, nor in a future 5G (i.e., more proximal) build-out.

With regard to municipal assets that rely on this (or another powered communications network), these sensor/effector payloads sometimes have very short term (e.g., <10 minutes) emergency batteries, but are (other than lighting) useless in the absence of the independently-provided communications connectivity. With regard to emergency responder/coordinator command and control, emergency radio networks exist, and also some limited inter-agency networks, which allow a minimum of voice-only connectivity (i.e., no IoT-based data and computing coordination, no video, etc.), and only for those responders who have access to this specialized equipment, and under the presumption that it has been independently maintained and is still operational.

However, the prior solutions/approaches have shortcomings and/or limitations. For example, there are five fundamental shortcomings, as well as the fact that these shortcomings presume the presence, maintenance, and readiness of emergency-specific assets: 1) they do not have a mechanism for continuity of operations as their small local batteries are depleted, 2) with the exception of emergency radio networks, they assume that restoration to ‘normal’ is proper, and do not re-organize to needed area-wide coverage, 3) they do not use the otherwise viable ‘fragments’ of the normal Utility power Distribution network, requiring, instead, a purpose-built power infrastructure, 4) they do not provide IoT services to emerging municipal infrastructure, meaning that only specifically designed components are carried forward to emergency operations, and 5) as such, emergency services do not include municipal lighting, cameras, loudspeakers, and the large emerging set of 5G-connected public safety sensor/effectors that operate only at short distance but high frequency (i.e., 5G Small MIMO), to include automated traffic coordination, autonomous vehicles, shot detection, public 311/511/911 portals, image-based dispatch of hazard response, sanitation and road repair crews, air quality monitoring, etc. It may also be that the 5G providers can allocate some types/amount of public access to the emergency 5G network.

These and other deficiencies exist. Accordingly, there is a need to provide systems and methods of emergency response and Continuity of Operations (COOP) area-wide power grid for 5G and associated municipal sensor/effector clients. The systems and methods disclosed herein can provide opportunities to make some amount of LTE access available to the public, as opposed to just emergency response and/or COOP. That is, there is a huge personal dependence on connectivity (beyond just ‘informing loved ones’) that could be considered a COOP function, even though not managed by the government. The systems and methods disclosed herein can also provide opportunities that the assets to be used in this emergency and COOP response are always in a state of tested readiness, they being the same assets that are used in normal LTE and Grid functions. This distinguishes the systems and methods described in this enclosure from existing ‘emergency response’ systems, which rely on a separate set of hardware and, usually, older and poorly-maintained equipment and technologies, including additional/directed testing, funding, etc.

### SUMMARY

Aspects of the disclosed technology include systems and methods for forming an emergency response and Continuity of Operations (COOP) area-wide grid-of-microgrids. Such grid-of-microgrids is capable of powering critical IoT and LTE-dependent infrastructure in an ‘as-possible’ manner.

Embodiments of the present disclosure provide a method of forming an emergency response and Continuity of Operations (COOP) area-wide grid-of-microgrids. The method can include: upon an power outage occurring to an Utility power Distribution grid network, identifying one or more nodes having an attached electric vehicle service equipment (EVSE, i.e., ‘charger’) and electric vehicle (EV) capable of, and ad-hoc acknowledged as available to provide, bidirectional power; forming at least one powered microgrid comprising the one or more nodes capable of re-establishing area-wide emergency or COOP services; activating a communication payload on the one or more nodes; restoring communications via the communication payload; and forming an area-wide grid-of-microgrids based on the communications of the communication payload and the at least one powered microgrid. In some embodiments, the communications payload can be considered a ‘Utility’ with regard to the emergency and/or COOP infrastructure, just as is the power to allow that communications payload. What is needed herein is the ability of the asset payloads (such as the communications payload) to be powered and connected to communications sufficient to perform essential emergency/COOP-specific sensing and/or command and control. The systems and methods disclosed herein can enable and make use of the self-organizing, best possible, power/communications infrastructure on the existing power Grid that are not redundant with Grid-normal power, communications, and payload assets.

Further features of the disclosed invention, and the advantages offered thereby, are explained in greater detail hereinafter with reference to specific example embodiments illustrated in the accompanying drawings, wherein like elements are indicated be like reference designators.

### BRIEF DESCRIPTION OF THE DRAWINGS

FIG. 1 is a schematic illustration of a context in which the present disclosure can operate in accordance with one exemplary embodiment.

FIG. 2 is a schematic diagram illustrating the telecom overlay in that infrastructure described in FIG. 1, in accordance with one exemplary embodiment.

FIG. 3 illustrates an image of some stylized examples of these multi-purpose streetlight poles in accordance with one exemplary embodiment.

FIG. 4 illustrates a diagram of a streetlight pole with payloads and their electrical demands in accordance with one exemplary embodiment.

FIG. 5 illustrates images of some locally deployed 5G Small LTE MIMO systems in accordance with one exemplary embodiment.

FIG. 6 illustrates a diagram of forming a microgrid/clique having different nodes in accordance with one exemplary embodiment.

FIG. 7 illustrates various optional manners in which an automated metering infrastructure (AMI) system sees and controls power sources and loads, in accordance with one exemplary embodiment.

FIG. 8 illustrates the location and control of meters as switches and meter revenue collection points on each node, in accordance with one exemplary embodiment.

FIG. 9 is a schematic context in which the present disclosure can operate in accordance with one exemplary embodiment.

FIG. 10 illustrates a diagram of an example grid-of-μGs in accordance with one example embodiment.

FIG. 11 illustrates a diagram of another example grid-of-μGs in accordance with one example embodiment.

FIG. 12 shows diagrams of example connectivity of payloads in accordance with one example embodiment.

FIG. 13 shows a diagram of an example grid-of-μGs formed on an Utility power Distribution network, in accordance with one exemplary embodiment.

FIG. 14 illustrates a schematic diagram of an example smart city in accordance with one exemplary embodiment.

FIG. 15 shows a diagram of example interconnected smart nodes in accordance with one exemplary embodiment.

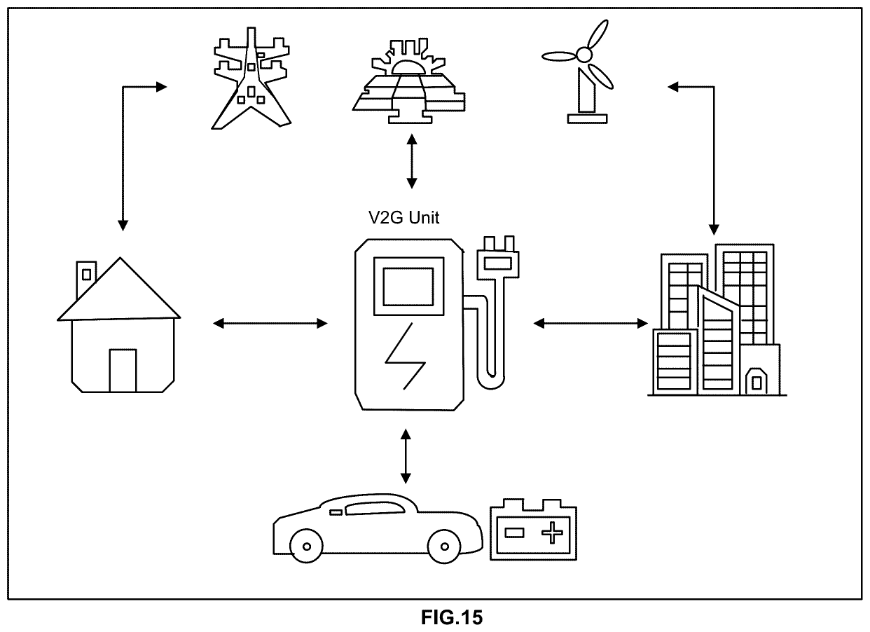

### DETAILED DESCRIPTION OF EXAMPLE EMBODIMENTS

The following description of embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

The present disclosure provides a set of mechanisms (physical and processing) by which any ‘available’ amount of post-disaster or post Grid-loss infrastructure will self-restore, and do so in a resource-constrained yet resource-optimizing manner, even in the absence of Grid power, so as to re-establish essential services. In essence, an area-wide Grid is reestablished, from the same Grid assets, although it is a grid that is specific to emergency response/COOP assets, including limited but more general IoT connectivity. Specifically, an emergency response and COOP area-wide power grid for 5G and associated municipal sensor/effector clients can be established by the present disclosure.

It should also be noted that the disclosed solution utilizes normal operational systems and, as such, is always in a known state of readiness, and does not require an incremental cost, including of independent maintenance and testing.

One exemplary process provided by the present disclosure can comprise a three step process, each step requiring and applying otherwise on-Grid physical and computing assets (i.e., assets already on the ‘normal’, Utility-provided, all-access Grid), but in manners unique to the problem solution and to the specific stage of the solution. During Grid outages, a ‘grid of microgrids’ is formed from these same Grid circuits, but using power sources available for self-isolation and activation, applying this power available from electric vehicles that have, ad-hoc, declared their availability for such services to emergency response payloads on those same circuits (now available to these isolated microgrids, ‘μGs’) in a manner commensurate with the number of viable assets in a given area. This viability can consider both available power and functional device availability. That is, regardless of the number and type of available and viable assets, this collection of emergency-response grid-of-microgrids is formed and configures automatically into a ‘best possible’ area-wide coverage of priority (i.e., emergency-specific) power and functional capability.

This term, ‘grid-of-microgrids’ is used here to name the disclosed solution, but do note that it is a functional area-wide grid, and not a physically connected grid per the conventional application of ‘Grid’ to refer to the wires that connect physically every device that is ‘plugged into’ the Grid. The term ‘grid’ in grid-of-microgrids refers to the total area of functionally connected communications infrastructure and enabled IoT sensors/effectors, even though the power for those interconnected devices is provided separately.

This ‘best possible’ calculation is a dynamic and locally determined algorithmic approximation of what would otherwise be fully expressed mathematically as an nondeterministic polynomial-time (NP) complete (and NO-hard) problem, a compute-intensive set of problems characterized by the ‘clique’ family of configuration identifications, O(n^{k} k²), further complicated by additional polynomials per viability of the available power resources, multiple useful clique sizes, viability of the sensor/effector/communications payloads, and neighbor state (i.e., power source/propagation vs. clique boundaries). Although calculated locally (as necessary per the loss of Grid power and normal communications infrastructure), the detailed approach shows that there are three points in this process of establishing the grid-of-microgrids configuration at which this local processing does perform distributed coordination, first at the level of sensing the power status of ‘neighbors’, then when communications are reestablished, and, finally, in the tailoring of functional emergency response resources to a situation-specific network, in which some resources operate in manners quite unlike their on-Grid ‘normal’. Because this grid-of-microgrids forms on severed Utility assets, the Automated Metering Infrastructure (AMI) which has its own communications network and ‘last gasp’ functions even after power is severed can also provide some amount of ‘centralized’ coordination as the emergency, and severing or possible incapacitation of resources, is first occurring.

Additionally, the manner in which the ‘emergency grid’ is established also allows it to transition into the COOP mode that can plan and revise its own functionality over time, but which is also available (once established) for coordination with centrally-directed assets and systems. This includes access to those Grid-powered and uncompromised resources that have continued, or recovered, normal operations, and which will then also bring to bear additional computing resources for more complete optimization of the previously locally approximated O(n^{k} k²) configuration as determined during the self-configuring of resources. Algorithms to address the initially local and subsequently centralized NP-hard control/participation of resources are central to the disclosed approach.

In summary, in the present disclosure, the described solution to the loss of Grid power, and commensurate need for emergency services of an increasingly IoT nature, can comprise (a) the manner in which already-available on-Grid resources are reformed on portions of the normal Grid, these portions being electrically isolated as microgrids, and the microgrids are electrically isolated from both the Grid and each other; (b) the manner in which power for the operation of these microgrids is harnessed from as-available (and willing) electric vehicles (EVs); and then (c) the manner in which emergency functionality known to be co-located on these microgrids is applied as a full-area, emergency-specific and emergency-function-unique, set of resources, to include controlled 5G access (with TBD public bandwidth, per the specific nature of the compromised system, or per scheduled access), and which is tolerant of (i.e., responsive to) any further losses of power, communications, or payloads using those communications channels.

The solution/approach provided in the present disclosure can overcome/minimize the shortcomings/limitations of the prior solutions/approaches. (1) Mechanism for continuity of operations: a single EV can provide the power for the communications and sensor/effector emergency management assets on a given street pole for days, and the manner in which the functionally networked (but electrically isolated) grid-of-microgrids provides this functionality allows for the removal/depletion of a given EV energy source, and also allows for the replacement of power by bringing another EV, perhaps as the larger battery in a school bus or transit vehicle, to ensure the continued or even expanded operation of a given suite of resources. (2) Restoration to ‘normal’ is not assumed to be proper (as it would not provide area-wide coverage, if any given restored element worked at all, without off-board support, in its ‘normal’ mode): in a ‘disaster’, including a prolonged electrical outage, it can be assumed that a limited total set of assets remains viable, even if power is eventually restored. To restore some limited number of these resources to ‘normal’ would not result in area-wide normal functionality. Indeed, many of these assets will not do anything useful unless the complete and normal network is in place: communications, back end processing, operator access, logging, etc. The approach disclosed herein can reconfigure the functionality of the communications and sensor/effector payloads in a manner that provides emergency-specific functionality over the entire area of outage. This is provided as a software-only change to the normally on-Grid systems. This said, the goal of the overall systems is that, to the extent possible, devices will operate in their ‘normal’ modes, thereby avoiding the incremental development and support efforts. (3) Uses viable ‘fragments’ of the normal Utility power Distribution network: rather than requiring additional equipment, Utility infrastructure is utilized. And, these resources are in a known-ready state (subject to post-disaster-related self-analysis), having been continuously in use up to the point of the outage. Furthermore, this infrastructure is dominantly located in the public right of way, upon which many of the other communications and sensor/effector payloads are installed, or will be installed as ‘Smart Cities’ mature. Presence in the public right of way ensures access, which, during disaster response, is fundamental to recovery operations. This access supports the swap-out of energy sources, repair of key assets in the COOP network, or even addition of municipally-coordinated plug-in 120V assets (in a very limited manner that guarantees the viability of critical assets; if the COOP agent determines that public access is also possible, that would be the incident commander's (etc.) decision). Even when not in the public right of way (i.e., is located on private property), it is located within locational and access easements that allow for Utility support of the infrastructure. (4) Provides IoT services to existing/emerging municipal infrastructure: the restoration of both a 5G-based set of IoT services and the co-located municipal sensors/effectors provides an area-wide basis for both emergency response and COOP. Furthermore, the restoration of 5G, even though limited in capacity when compared to ‘normal,’ allows for the connectivity/use of IoT-based resources that are not specifically on this grid-of-microgrids. That is, other independently-powered (e.g., private microgrids and/or sites otherwise under their own emergency power), but which are dependent on 5G/IoT access for their functionality, are serviced by the grid-of-microgrid provided network. Under the presumption that subscriber access will need to be metered to the available bandwidth (a function already possible by telecom system control) and provides the ability to focus this limited bandwidth on critical civic infrastructure, this means that any other 5G/IoT-based off board system has connectivity, assuming that the off-board resource itself has power, is functionally viable, and has been granted access to the bandwidth. This would include access to the traffic and vehicle management systems, hospital/banking/court (etc.) data access systems normally on wired connectivity, etc. (5) Emergency and COOP services include municipal lighting, cameras, loudspeakers, and the large emerging set of 5G-connected public safety sensor/effectors. As shown in the following details, almost all of the real-time municipal public ‘sensing’ infrastructure, as well as device control and emerging public-interactive elements, is almost by definition present in the public right of way. It is these very ‘access’ corridors that the present disclosure addresses. By establishing both power and information connectivity (as addressed above), these devices continue to operate, even if functionally recast to emergency or COOP functions. (6) It should also be noted that the disclosed solution utilizes normal operational systems power, communications, and municipal sensors/effectors and, as such, is always in a known state of readiness, and does not require an incremental cost, including of independent maintenance and testing.

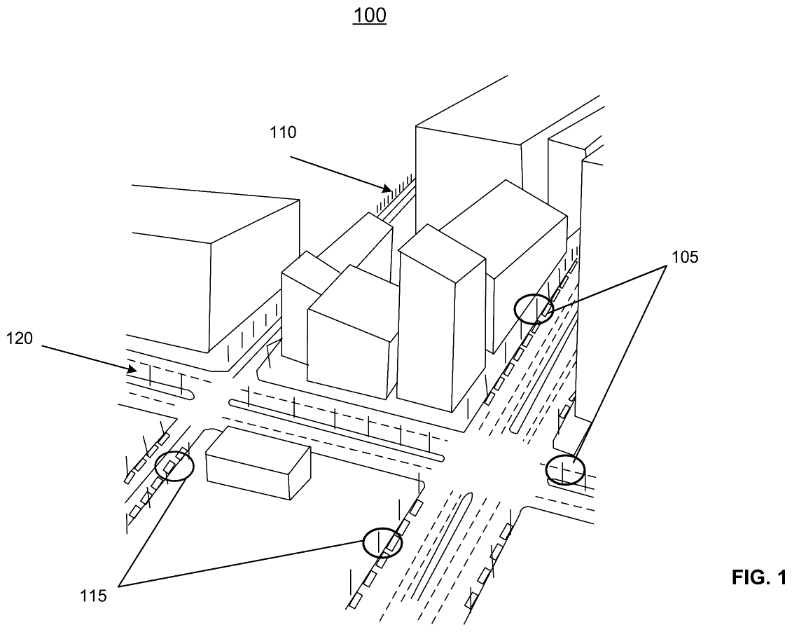

FIG. 1 shows a schematic illustration 100 of a context in which the present disclosure can operate in accordance with one exemplary embodiment. The illustration 100 can comprise Utility streetlight poles 105. All of the streetlight poles 105 are configured to have lighting ability. Some of the streetlight poles 105 can be configured to have electric vehicle service equipment (EVSE). Some of the streetlight poles 105 can be configured to have Long Term Evolution (LTE) capability for a first company, such as a company A. Some of the streetlight poles 105 can be configured to have LTE capability for a second company, such as a company B. Some of the streetlight poles 105 can be configured to have ‘smart city’ payloads, such as cameras, air sensors, and info/911 kiosks. Some of the streetlight poles 105 can be configured to have all of the above.

The streetlight poles 105 may be configured to be less than 100 feet apart, such as from about 80 feet to about 100 feet apart (more if the streetlight poles are taller and streets wider), whereas the needed 5G LTE antennae must be about every 300 feet to 1000 feet apart, per both line of sight and the density of clients in a given area (and given the limited carrier distance of the RF frequency used). And, that density needs to be repeated for each competing service provider. It should be noted herein that the disclosed system and method can be applicable even to the currently-envisioned 6G-based communications.

EV ‘chargers’ on these same streetlight poles would only be where there is parking access, and market need. The word ‘charger’ is set off because these are charging or power release devices. Although most home and destination chargers today are capable of only charging (i.e., one-directional energy transfer), and at relatively low power (i.e., 6-7 kW), and most vehicle battery management systems are only configured to receive charges, this is not going to be the future case. International standards bodies have certified bidirectional capabilities (i.e., Vehicle-to-Grid; V2G) of the Asian charging connector variant (CHAdeMO) for over a decade, and the major U.S. and European variants (CCS1 and CCS2, respectively) are nearing certification with many U.S., and European manufacturers already delivering commercial instantiations in advance of the Standards. All U.S.-manufactured electric school buses are, for example, V2G capable and using the CCS1 U.S. connector standard. Furthermore, while faster ‘roadway’ chargers are 3-phase, 480V, high power devices that cannot be installed at streetlight locations and most public parking circuit types, there are now lower-power, single phase 120V and split phase 240V Grid-interconnected, but direct current (DC, to the vehicle) and V2G capable, lower power chargers. Their price is already approaching parity with conventional alternating current (AC), uni-directional chargers. These lower-power DC fast charging (DCFC) V2G devices, in ubiquitous charging locations where vehicles are left connected for periods longer than just a fueling stop (i.e., parking), are both faster at charging vehicles and, importantly to this disclosure, allow vehicle owners to access the value of their vehicle battery for market participation (some small number of thousands of dollars annually, given typical battery sizes and energy markets) and other possible uses (e.g., resilience in the form of home back-up power). The present disclosure leverages this market evolution to include wide scale emergency and COOP services, presumed to be an additional value stream for participating vehicle owners. These specific V2G public charging units (hereafter as the industry term EVSE, Electric Vehicle Service Equipment) can provide Grid-type AC power for these types of streetlight pole loads for days.

The illustration 100 can include Utility power poles 110, which, as opposed to the streetlight poles 105 (the latter of which may or may not be Utility-owned, but are always Utility-energized) are typically made available for 3^{rd} party device connection above the power lines (where the antennae must be) under very constrained conditions, and far lesser numbers, and are not even typically available in many urban settings, in which installation via underground wiring is preferred. That is, underground routing is typical in urban settings, and above-ground power poles do not typically have 3^{rd} party wires or devices above the power lines. However, every place that there is a streetlight pole, and even (with additional constraints,) power poles can be viewed as a point of connection to the Utility Distribution system, and, as such, is also subject to municipal guidance with regard to the attachment and use of those devices, even if owned by a particular entity (e.g., power or telecom Utility), other than per considerations of safety, co-site interference, etc.

Traffic lights have been omitted from the illustration 100, but do exist on the same Utility power infrastructure, and are examples of ‘off board’ municipal assets that interact with the other assets named into the grid-of-microgrids.

The illustration 100 can further comprise parked vehicles 115 near the streetlight poles 105. The illustration 100 also indicates that some median streetlight poles 120 may not be allowed to have EVSE.

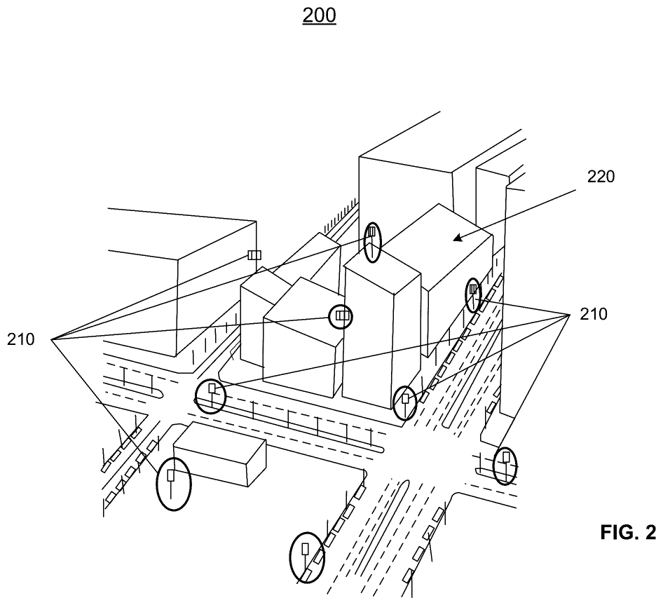

FIG. 2 shows a schematic diagram 200 illustrating the telecom overlay in that infrastructure described in FIG. 1, in accordance with one exemplary embodiment. The diagram 200 shows 5G LTE antennas 210, and also indicates in-building LTE devices 220. Larger 4G base stations are not depicted in the diagram 200. Indeed, in the current very nascent deployment of true IoT-ready 5G, the 5G signal format is being carried only by these same 4G towers, and at the same lower bandwidth frequencies. The deployment of 5G MIMO antennae, almost all of which also act as their own base station (in that they are also fiber-hardwired), has barely begun. Literally millions will be deployed in the U.S. This class of ‘cell towers’ has little in common with prior deployment issues, being 1/10 the cost (and dropping) and also houses much more capable local hardware and software: low power, software intensive yet encapsulated, much more flexible AESA (Active Electronically Steered RF Array) beamforming/detections/tracking/power control, etc. 5G small MIMO systems are deployed and energized into the production telecom system in days, not months. The flexible local AESA and processing capability allowing each station to work in manners far outside the normal operating parameters, and is a critical element of the envisioned solution. Any given node can become a repeater as opposed to a client gateway, can be directed to operate beyond the standard range by altering S/N and bandwidth expectations, can tune to emergency-specific frequencies, can operate as a base station even in the absence of fiber connectivity, etc. Indeed, these AESA devices can be reprogrammed as emergency/disaster-specific sensing device (vs. communications devices), but that is left as the subject of someone else's interest.

In the diagram 200, the overall cellular network (5G) can be characterized by: (1) 5G is an overlay to 4G, (2) large 4G/5G base stations still exist, (3) each 5G LTE (small MIMO) ‘Pole’ uses 3-5 kW of power and is fiber connected (i.e. RF is usually only client I/O), and (4) the 5G high throughput (high frequency) LTE antennas are line of sight and may be about 500 feet apart for each carrier. For the 4G network, each tower is a base station, 1-2 miles apart, and uses beamforming, but in a much more limited manner than 5G, and at lower frequencies. The 5G LTE antennas on buildings or other private property may lose power when Utility grid power is lost. The in-building LTE devices may be public or private. A city may require many such antennas per carrier. Placing 5G LTE/MIMO systems on streetlight poles, or other small poles in the public right of way, is the easiest way for telecom providers to add this functionality and is, indeed the manner in which they are doing so, (vs. on power poles or private property), particularly with existing pole/power. As used herein, the term “telecom”, can comprise mesh communication networks, WIFI communication networks, and so on. The mesh communication networks and WIFI communication networks may be dependent on LTE at some point in their effective propagation of information and C2 functions, and even just their own power requirements, when co-located on the grid-of-microgrids network.

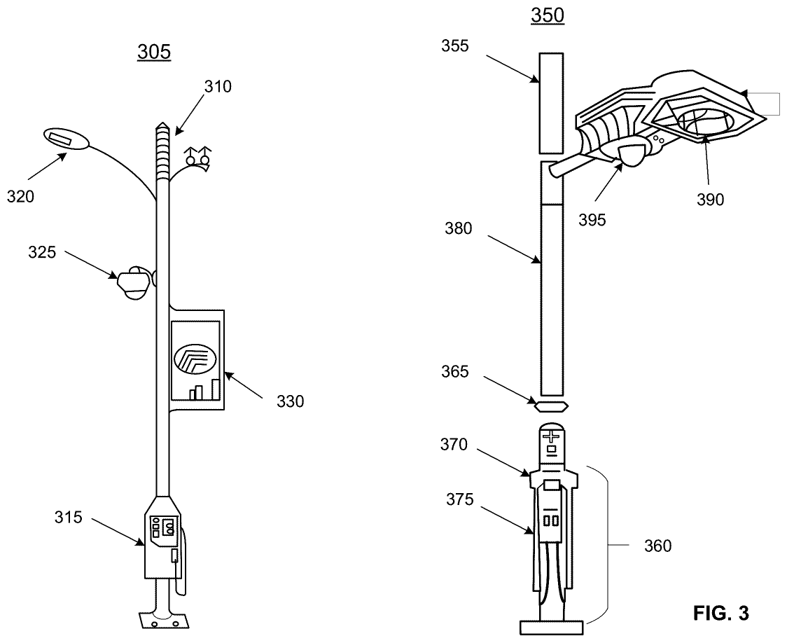

FIG. 3 illustrates an image of some stylized examples of these multi-purpose ‘streetlight’ poles 305, 350 in accordance with one exemplary embodiment. The 5G Small LTE MIMO antenna is the cylinder (also referred to as upper antenna module) 310, 355 at the very top. The ‘Fast Charge’ EVSE is the device 315, 360 at the bottom ‘fast’ in this case referring to the DC nature of the bidirectional EVSE unit, although slower than highway DC chargers, per limits of typical utility pole power, in this case with only a single vehicle ‘port’ (most in this context would be 2 port systems to optimize infrastructure vs. parking geometries). In a 2 port configuration, the total Amperage on any given circuit (including the inverter and system design) will allow the overall system to apply full power to one port, or half of the possible power to each port, assuming that each port/vehicle needs at least half of the available power. This would be of obvious benefit to maintaining the existing in-operation configuration of a grid-of-μGs, rather than both interrupting the operation of the existing microgrid payloads and having to reconfigure the operational configuration of the overall network. A dual port system similarly has market and user benefits during normal operations, as the shared inverter, operator I/O, service provider backhaul components, and electrical service connection/metering (these 4 components being the bulk of the system cost) are common to a single or dual port system, while providing twice the user access.

The streetlight poles 305, 350 may each comprise a shroud, a base cabinet, and a foundation, in which a V2G system and/or dual cable <25 kW DCFC charger may be housed (a split phase 240V connection, such as would be found in typical urban circuits, can only power units up to ˜22 kW, and a 120V circuit even less). The streetlight poles 305, 350 may each also comprise an upper pole. For example, the streetlight pole 350 may comprise a shroud 365, a base cabinet 370, a foundation 375, and an upper pole 380. The streetlight pole 305 may further comprise an LED streetlight 320, cameras or sensors 325, a display 330 (e.g., a liquid crystal display or an LED for pedestrian interaction and also is low power). The streetlight pole 350 may further comprise a LED streetlight 390 and cameras/sensors 395.

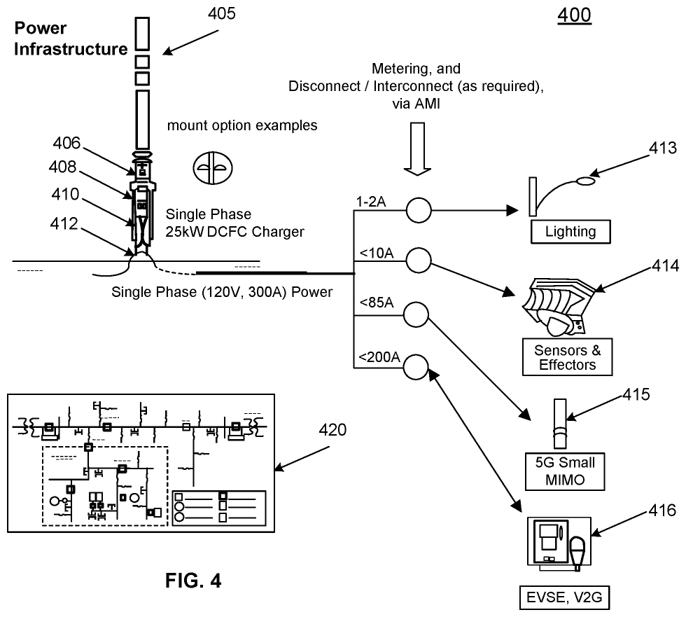

FIG. 4 illustrates a diagram 400 of a streetlight pole 405 with ‘payloads’ and their electrical demands in accordance with one exemplary embodiment. The streetlight pole 405, similar to the streetlight poles 305 and 350, can include a V2G Inverter System 406, a shroud 408, a base cabinet 410 and a foundation 412. Regardless of location on a dedicated or pass-through transformer circuit, or overhead vs. underground, each streetlight pole is independently controllable. As shown in the diagram 400, a single phase power such as 120V and 300A can meet the power demands from all the payloads, such as lighting, sensors/effectors, 5G small MIMO, and EVSE. For example, a lighting payload 413 can consume about 70-150 W, which can be replaced with efficient LEDs (1000->70 W), and address downlighting with respect to light pollution. Sensors and effectors 414 can consume less than 1 kW, which can offer limited existing services, often on unique poles and with only minor transportation value (i.e., traffic cameras). While cities have right-of-way access, power and communications can drive cost. A 5G small MIMO 415 can consume about 5-10 kW. Power is a function of the number of MIMO signals supported and range. The industry response is these “small” MIMO antennas, requiring a larger number of transmitter/receivers, particularly in urban areas. EVSE/V2G 416 can consume about 20-24 kW. On-board inverter supports ‘L2-like’ destination charging, but 3-4× faster and with significant V2G energy exchange. EVSE/V2G 416 can be located where urban, multifamily, and underserved communities have EVSE infrastructure challenges. (Streetlight nodes may be 120V or 240V. At a 120V connection, the 5G small MIMO and other payloads would be fully-supported in either the Grid-normal or emergency/COOP configuration. However, V2G payloads (i.e., EVSEs) and other clusters of higher power assets will be located on 240V split-phase nodes, but can distribute power, in the grid-of-microgrid configuration, at both 240V and 120V to neighboring nodes.) As shown in the block diagram 420, a piece of the circuit that shows that the Utility ‘pre-meter, pre-pole’ circuit is essentially just ‘tapped’ by each streetlight (i.e., the Utility meter(s), with the pole payloads on that tap, not on the ‘passing’ circuit). The Utility decides how many of these poles are run on each linear circuit, with a single Distribution transformer having converted the proximal-to-the-Utility-source Primary voltage to the 240V or 120V that energizes each pole and runs the length of the circuit of multiple poles. That transformer is not pictured herein, but is along that linear circuit somewhere, and at the end of that circuit at the end closest to the Transmission line source of that Primary voltage (also as ‘Distribution voltage’). The total power requirement of all loads on that circuit must be met by (or is ‘defined in design as’) the rating of the transformer used (and nuances of conductor size, circuit length, etc.), which can therefore meet the expected total load on that circuit (in this case a linear circuit, but that's not the only option).

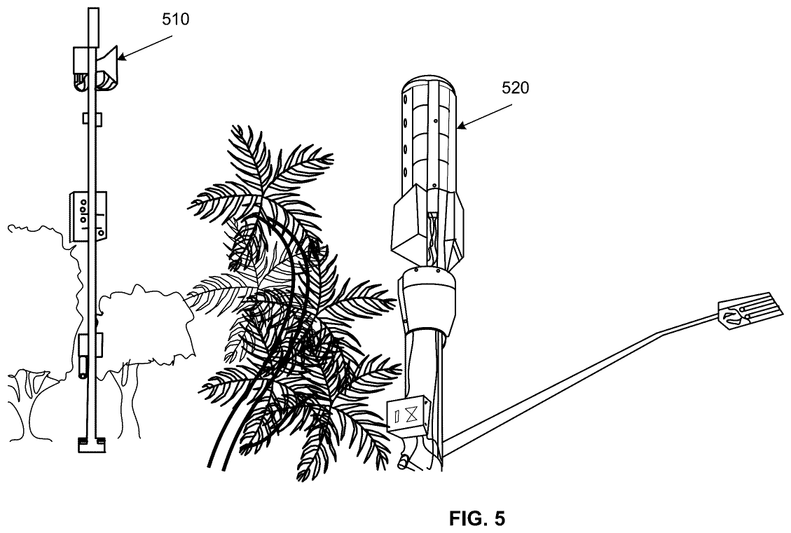

FIG. 5 illustrates images of some locally deployed 5G Small LTE MIMO systems in accordance with one exemplary embodiment (the DFW metroplex is one of the early commercial deployments of 5G and 5G LTE Small MIMO functionality). As the industry deploys increasing numbers of these 5G LTE antennae, and as the integration of the various associated payloads becomes a more cohesive element of municipal guidance with regard to access to the public right of way, commonality of the power and communications elements of the infrastructure will become standardized. Such standardization would address not only the payload(s) as physical connection standards, data/power standards, payload performance types, etc., and cosmetics. The electrical infrastructure will have to comply with Utility connection standards and if also exporting energy, Interconnect standards. The solution/approach provided in the present disclosure leverages these conventions, yet in manners that do not add requirements to applicable Standards and common Utility practices. In the images, the 5G small LTE MIMO systems are indicated, such as 510 and 520.

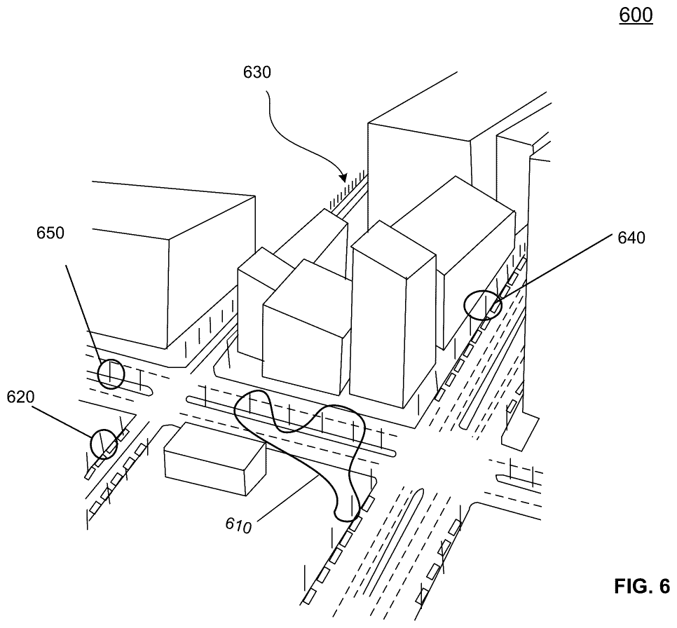

FIG. 6 illustrates a diagram 600 of forming a microgrid having different nodes in accordance with one exemplary embodiment. In the diagram 600, formation of a clique (i.e., one microgrid 610 in the grid-of-μGs) has to be done at both the power level (the ability to energize the units), and at the functional level (the best-fit manner of using all available assets to cover the area with priority functionality), and that both rely on some off-node communications or at least sensing. Without yet addressing the details of how that ‘best fit’ is realized, here are the manners in which the requisite electrical isolation of microgrids is established (again, not saying that this must happen first, nor yet how this relates to the functional clique groupings).

In the diagram 600, the ‘microgrid’ or ‘clique’ 610 can comprise one or more power node(s) and is electrically isolated from the Utility grid (regardless of grid state), with a local voltage and frequency reference. An example ‘Power Node’ 620 can comprise a streetlight pole having presence of a participating vehicle with available energy on that streetlight pole. Each streetlight pole is referred to as a ‘node’ regardless of configuration, for example, nodes 630. ‘Payload’ refers to one or more of the powered devices on a streetlight pole. Normally, the EVSE would not during emergency operations be considered as a payload. However, if a microgrid (clique) had two or more EVSEs, and some are charging vehicles, those would be payloads. The city or Utility might do this by bringing larger vehicles, charged elsewhere, to the microgrid. An example streetlight pole having payloads is indicated as 640 in the diagram 600. Each node, and each payload, is independently visible to the Utility AMI system (i.e., metering, but as Advanced Metering Infrastructure, also referred to as ‘Smart Meter’). Each meter/submeter can also act as a switch, as well as sensor and revenue log, one example node of such is indicated as a node 650 in the diagram 600.

There are some assumptions to be stated. The μG is powered by a single reference-forming (i.e., voltage and frequency-defining) V2G system. Any other power sources will follow this reference; that is, they will ‘parallel’ with that unit, and with to-be-determined (TBD) impacts on how power from what device is used to meet the total μG load demands.

The V2G system can only output approximately 15 kW of power. This is a product of a few other assumptions: (1) This urban parking style of DC Fast Charge (DCFC) EVSE will not be of the 60-360 kW ‘highway charging’ style; (2) The otherwise ‘lighting’ circuits on which these are placed are single phase or split phase 120 or 240V circuits (per city/Utility convention), and may not but ‘do not’ support the highway chargers larger EVSEs; (3) To the extent that any given node, or a daisy-chained set of nodes (an option discussed in the following description) is rated below a 200A 240V max load, the conventional Utility AMI meters can also use the embedded relays to open or close the circuit to the load, effectively acting as switchgear for the loads behind the meter relays (i.e., distal to the local power source). The Utility AMI system uses these for remote service connection and disconnections, although typically only at the time of a new or terminated ‘all premise’ service request. The meters are physically capable of the circuit disconnect/reconnect (even under power), and the Utility AMI is capable of remotely commanding a disconnect/reconnect, and local processing could be directed at automated conditions under which these should be performed, but confirmation is required that product designs would allow routine and rapid access to the functions, including when powered only by local capacitors that are also performing ‘last gasp’ RF messaging; and (4) Although it is likely that it can support (and on-Grid market operations would desire) service at up to 25 kW, 15 kW is a good working assumption, and supports all the loads on even a fully-populated node, and even a few neighboring nodes (5G LTE/MIMO-inclusive).

The AMI meters can operate as switchgear, including independently of commands from the normal Utility 802.15 mesh network (i.e., under local processing logic). And, once an AMI-mediated circuit (whole node or payload) is re-powered (or is on a UPS), the same network can be used for coordination with proximal units, regardless of the presence of a centrally-coordinated mesh link to the Utility, or the use of normal repeaters. The optimal grid-of-microgrids configuration would have a minimum of 3 switchgear on each node. This could use the typical ‘can mount’ Utility meters (2U base in this single or split phase case), but even those 2 way and relay-enabled (i.e., switchgear-resident) meters cost many hundreds of dollars, and each one can serve up to 200 A. And, this is precisely how existing Small MIMO deployments are being performed, with standard Utility 2U meter bases and most of the associated meters being AMI capable. In this manner, those sites are, from a Utility perspective, ‘sites’ in no way different than a house or business. This said, the transition of the industry to servicing so many new ‘small sites’ will lead to smaller metering variants, with the same functions, and at much lower cost. It is presumed that a modular solid state variant of revenue meters would be applied in this on-pole (node) application (indeed, in-pole).

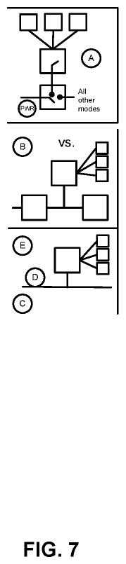

FIG. 7 illustrates various optional manners in which an AMI system would ‘see’, and control, the power sources and loads, in accordance with one exemplary embodiment. These above assumptions are addressed in FIG. 7, but expanded upon to show the various optional manners in which the AMI system (whether locally, centrally, or in cliques) would ‘see’, and control, the power sources and loads. A preferred approach is noted (case (3) in FIG. 7), but there are many viable mechanisms. An important consideration is how control would be exercised during ‘restoration’; that is, how the node and resident loads and energy release (from EVs) is managed when re-joining the powered grid. Normally, all AMI switches stay closed upon power loss, and just ‘black start’ when power flows once again from the Utility. It is as if the switches are not there. This cannot be done in forming a which must ensure that all local power sources are isolated from the Grid, and are also turned off before the Utility power is re-applied (or, alternatively and expensively, can actively synchronize with the Utility voltage/frequency reference; this disclosure does not preclude a synchronous restoration).

Seven viable grid-of-uGs forming (and restoring) AMI switching schemes are shown in FIG. 7. Tradeoffs are addressed between Utility ease of use (typically associated with restoration) and the time/processing required to establish the cliques (not yet addressing desired payload coverage/functions, which is described later). Also note that the role of the meter itself in performing a variant of the conventional ‘last gasp’ processing (what it does as it knows that it is losing power), is the primary difference in these 7 approaches. Normally, the last gasp only conveys status back to the central Utility outage management system (OMS).

In the following cases, the configuration of the meter as it enters this ‘no power’ state is contrasted with other options, addressing pros and cons of time to establish the grid-of-microgrids, availability to subsequent functional (i.e., non-power) configuration, integration complexity (particularly with regard to restoration to the Grid, once normal), cost (due to number of meters/switches or ‘smartness’ of meters/switches), impacts on back end AMI data stores/settlement/log correlations, etc.

These 7 cases are: (1) All AMI meters fail open; (2) As above, but having a small local backup battery (i.e., one that operates longer than today's capacitor based, loss-of-Grid ‘last gasp messaging/operations); (3) As (1) or (2), but with a modified AMI meter that is Grid and (differentially) μG-sensing (requires Current Transformers (CTs) on both side of the AMI switch); (4) Form, upon Grid failure, an a-prioiri set of power (vs. functional) cliques, which requires that some AMI nodes are pre-configured to ‘fail’ open, and some ‘fail’ closed; (5) All non-EVSE nodes fail open; (6) All nodes fail and are open on the load side and closed on the Grid power side; and (7) As (4), but with a-priori functional (and also power) cliques, but before presence of available power is known. AMI smart meters measure not only the ‘revenue’ load distal to the Utility service (i.e., the premise), but the Utility side of the meter, and are therefore also ‘Grid aware’. This is NOT a requirement of standard revenue metering, but is. In the case of what the disclosure requires of those meters, they may not measure that Utility side, but must know if there is power present, as all AMI meters do. The meters used to form the grid of microgrids must observe both the Utility and client ‘sides’, which is referred to as ‘differentially’. The measurements needed on each ‘side’ of the circuit are also not the same.

For the first case (1) that all AMI meters fail open, it is presumed that all AMI meters fail open. AMI meters are required to find available neighbors, which is different from a central AMI (same as finding hop modes) have numbers (part of last gasp). The last gasp can include status, open to feeder, and closed to dithal. This can only solve problem of adding ‘upstream’ modes. Only the leaf modes would “miss” the non-power modes ‘below’ it. That is, power is only shared upstream. Requirement is placed for normal restoration to reclose—yet not all are on normal AMI saved. With safety interlock, this can allow all to be either 1) clique, or 2) to remote actually, which just needs to command for close/open (standard power off, restore all).

For the second case (2), cliques can be formed, but which still has restoration issue (cannot pressure much, days later). This could allow any μG to stay on, restore rest of grid, then drop μGs (thus abnormal modes, which modes already checked in central system), which, once reclosed, just become additional lead & block start. This may be a better version of #1 restoration too. Manual version of the above may be needed if grid restoration itself is in some way ‘not normal’ (e.g., emergency-specific grid-scale μGs).

For the third case (3), last gasp an include isolating mode. Power from μG must creep out, which requires sensing past open relay and neighbor, then commanding close (to μG side self (a “creep” side(s)). Then restoration is performed as described in the case (1) or (2).

For the fourth case (4), cliques can be formed but not yet as comms/payload cliques. Last gasp can have various power configurations. For example, this will be ‘it’ for cliques with respect to powered modes; this just starts process of finding and rejoining power & powered modes; this is done with once a-priori estimate of ‘pole’ clique; this is just network/5 (2 up, 2 down); or this is the mix 200 A circuit during clique (AMI limit). Overall, the fourth case is simpler, but only allows network optimization to event-specific losses, and even that would be a longer two-step process (but 1^{st} step is possibly faster than the cases (1)-(3).

For the fifth case (5), last gasp can indicate all AMI stay open, except EVSE modes, which isolates & (for those that can) start as 1-mode μG, but reach out to neighbors within last gasp period and open (of neighbor to power) CMD.

For the sixth case (6), last gasp can indicate Grid lead side. Grid or μG can power down but cannot cascade to all (not enough power). Case can be solved if relay closed and only on power & CMD.

For the seventh case (7), various a-priori open/closed mixtures can be formed, i.e., mixture open/close upon loss. This is similar to the case (4), but as clique for function vs. power.

Assumption and start state can include single place, 120 or 200 (any local convention) EVSE loads as 15-20 [all limitations] or just say “not the 60-350 on highway”; clique can presume usage 15 kW (20+ is possible); presume 1 clique for power mode (ok if later idle); many power mode can carry 3 load modes (including itself) with 5G or up to 6 in a reduced wattage mode, as well as any 2-3 non-5G modes @ 2-3 kW each; and presumes 5G big loads will curtail if power is low (mode as PQ voltage.)

There are additional at-Grid-failure switchgear configurations, but these seven primary cases allow discussion of the dominant pros and cons.

Note that the switchgear in AMI meters is currently only used for remote service disconnects or reconnects. The same remote switchgear functions could be applied to the solution/approach provided in the present disclosure. As the details presented in the following illustrations expose, restoration of the streetlight poles (and their payloads) to Grid power happens today because the switches are still closed, power gets restored, and the loads restart. In any grid-of-μGs in which the switch opens upon loss of Grid power, it must also have a means to auto-restore (i.e., reclose). It cannot be assumed that each node is under the logical control of an off-Grid microgrid (which would reclose the switch when the μG is terminated), as that node may not have been powered during the Grid outage. Adding CTs and switches as resident in any AMI meter on both sides or at least one side of the pole circuit (the Grid side) would allow a daisy-chained (i.e., proximal to the Utility, and cascading) reclosing of all nodes, as would CTs and switches under other ‘electrically signaled’ operations. Even with local batteries and a mesh radio, the presence of viable communications, local to the node, and power to reclose the relay(s) so as to conduct a restoration under an external signal cannot be assumed days or weeks later. The ability to detect whether energization of the Grid-facing CTs (current transformers) on a given node AMI meter (while open on that side) as being Grid vs. μG would alleviate these issues.

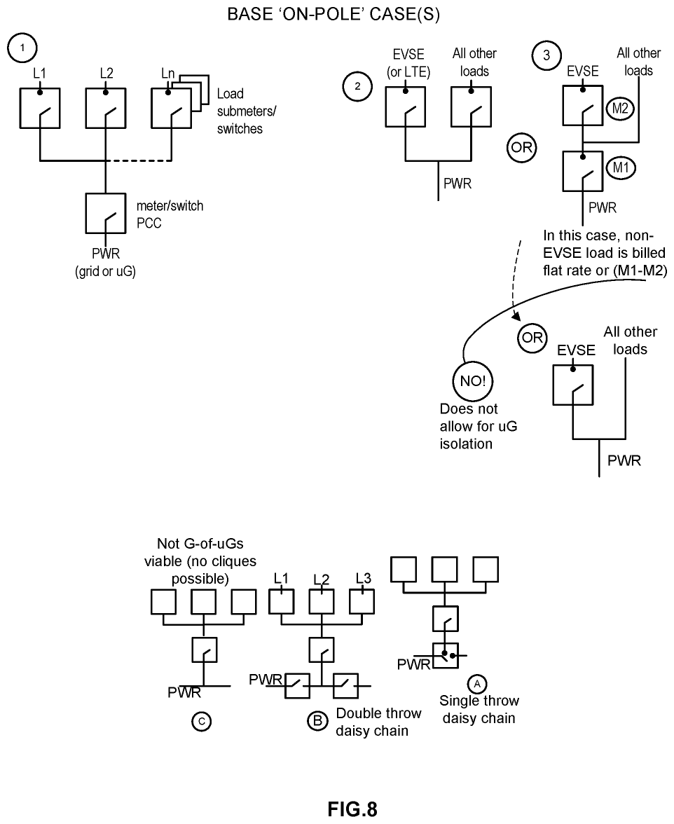

FIG. 8 illustrates the location and control of meters as switches and meter revenue collection points on each node, common to any of these 7 ‘last gasp’ configurations, in accordance with one exemplary embodiment. As shown in FIG. 8, the location and control configuration of meters may be categorized into three base ‘on-pole’ cases, such as cases (1), (2) and/or (3).

As shown in FIG. 8, the case (1) can be applied if payload is not needed, or if bit is bad, or while forming on-node μG (last case seems unnecessary). there could be a base case where only the ‘significant’ load is metered (also getting that AMI-enabled switch) as (A) EVSE only, (B) EVSE and 5G LTE, or (C) presumption (bad!) that 5G+EVSE do not co-exist which is simplest needed case of functionality to be restored! In each of the three viable ‘base’ cases, the power source is not labelled as a single, D-connected, metered PCC. It is possible that the last 200 A of a circuit is a daisy-chain, not even as a series of sub-metered loads, as each more-leaf-proximal node is behind (i.e. power distal) a more PCC. In such a daisy-chain, there are also various configurations as shown in diagrams (A), (B) and (C) in FIG. 8 (see also (A), (B) and (C) in FIG. 7) illustrations that assume base case (1), above. All elements of (A), (B), (C) are on a single node/pole.

Before returning to the generally sequential introduction of system component definitions and their configuration/activation in the grid-of-μGs (or restoration to normal Grid power and functions), there is an essential meta-topic to address. Indeed, the need to do so has passed a few times already: immediacy.

Note that there are many ways to ‘leave’ and ‘rejoin’ the normal Grid, or a failed/failing/anomalous-but-present Grid. It is very expensive to go on and off the Grid (i.e., potentially interfering with for the microgrid to restore or island) in an immediate ‘white start’ synchronous manner (i.e., one in which the client is mostly unaware of or at least not impacted by the outage, usually defined as a momentary interruption of <2-3 AC cycles and without introducing AC cycle phase changes). If there is a gap in time, then assurances have to be put in place to ensure that power will not be paralleled in unsafe (to equipment and people) manners, or such that can produce an unsafe situation by energizing a line under active repair (or otherwise activating a failed circuit, exposing the public and equipment to hazards). There are also electrical protection schemes (e.g., detection of fault current, or the inability to do so) that have to change between Grid and microgrid modes. And, if synchronized and immediate when islanding, the off-Grid inverter has to already be ‘on’ and operating while on Grid, as in the standard operation of an Uninterruptable Power Supply (UPS). (This is not quite reflexive in the restoration state, as the generator itself can ‘ease into’ Grid synchronization over time, and then switch into the Grid). A ‘black start’ is much easier, in which loads lose power momentarily when changing modes, and restart as if turned on again.

For existing Grid practices, there are multiple reasons to allow this delay. The first is that the Grid might well come back on after only a brief moment. It would be disruptive to create the grid-of-μGs, curtail many normal commercial IoT functions, and immediately have to return them to the normal state. The Utilities have auto-restoration sequences that try to reenergize circuits immediately, then after about a minute (at Distribution circuit levels) and then at about two minutes (at the Transmission bulk Grid level), after which the switchgear remains open until human-commanded local or remote control.

Currently, these Utility power auto-restoration schemes are sufficient to meet load demands, and at a specific capital outlay that is relatively inexpensive (also being offset by not needing to dispatch personnel for simple fuse/breaker resets). And, no area-wide ‘emergency’ exists per a brief outage. Select users (e.g., hospitals, large 4G base stations, data centers) take care of themselves, whether as control of momentaries or of short term outages.

But, none of them are prepared for prolonged local operations (unless additional fuel is forthcoming) nor for a concomitant outage of non-resident communications and internet access, whether prolonged or not. Nor would they be prepared for a REALLY long multi-day COOP or apocalypse-style outage. The grid-of-μGs can address such outages, for the core municipal emergency services. Vehicles with charges from ‘somewhere’ would have to be added for week-long (indeed indefinite) operations, but these are, indeed VEHICLES (i.e., are mobile, and most owners will have some level of interest in either or both of compensation and public service), but (per the grid-of-microgrids design) can be added in disorganized manners, yet functionality will adapt. And, for prolonged operations, this market-based EV participatory manner of forming the emergency power and comms/sensor/effector network is not the only way to power and continue the grid-of-μGs. Municipal, Utility, or State/Federal response could also bring vehicle and/or non-vehicle energy (as stored energy or generation) to a given microgrid, as established by the Grid-of-microgrids, to sustain operations and do so in a manner that requires only kilowatts of power, not the multi-megawatt scale of power that energizing even a ‘feeder’ Grid segment would require.

Although the grid-of-μGs is formed independently of considerations of Utility restoration of the core Grid, and can be cast under a white or black start requirement (per load client requirements), it certainly has to be designed to work with these other Utility operations. Cases 1-7 of AMI performance (above) described the pros and cons of the alternative approaches with regard to other Utility operations.

Also note that, in the near future (<10 years), the definition of user need with regard to immediacy will change drastically. Consider that, even today, there are more new phone numbers allocated each year to vehicles than to humans. Although hardware and software on the vehicles themselves will achieve much of future vehicle autonomy, much of the intelligent highways infrastructure that achieves urban transportation behavior requires off board collaboration, coordination between vehicles, etc., and is 5G based (the future Small LTE/MIMO-supported 5G, at 2-3 orders of magnitude (OOM) bandwidth, lower latencies, and 2-3 OOM numbers of participants, vs. today's ‘large 4G poles providing 5G compliant services’ version of 5G). Already today, coordinated traffic management (i.e., dynamic traffic lights and other highway signage, variable lane roadways, toll rates, etc.) works in this manner. In the future, even minor power interruptions could result in gridlock.

The present disclosure now describes the timing of establishing the grid-of-μGs. Having now identified the agents (largely automated) in effecting the envisioned system, and the operational goals or constraints of that system, the present disclosure can now address the overall mechanisms to achieve the system.

In the first phase of forming the emergency grid, the small batteries that would conventionally provide short term continued normal operation are, instead, allocated to providing enough power to identify any available larger-scale power, upon which the set of microgrids will be formed on fragments of the Utility Distribution grid, those fragments being specifically the streetlight pole circuits in public right of ways upon which 5G Small MIMO assets (from various commercial suppliers) and also various municipal assets of value to emergency response are located. As noted earlier, it is possible to use the ‘last gasp’ AMI meter capacitors to establish the power (only power) cliques without a local backup battery, but in sub-optimal manners.

Included on a subset of these streetlight poles, referred to hereafter more typically as ‘nodes’, are EV DC Fast Chargers (DCFCs), this being one type of Electric Vehicle Service Equipment (EVSE) and, although quite limited in power when compared to three phase highway DCFCs, can provide AC energy for these streetlight pole types of loads for, potentially, days, if the right type of EV is on the circuit and is willing to participate.

This first phase of emergency grid formation is to therefore identify a subset of the vehicles attached to the EVSEs that are of both (a) the type that support reverse power flow (Vehicle-To-Grid, V2G) and (b) have been previously ‘marked’ by their owners as being available for bi-directional on-Grid or off-Grid services (under conditions of, for example, energy price points and the vehicle state of charge), in this case the provision of emergency power to these to-be-formed microgrids that the Utility will orchestrate around these power sources.

For example, in the Texas market, the value of electrical energy during such outages can be more than 100 times the value as when the vehicle was being charged, and, in addition to the wholesale market defined pricing, an Uber-like real-time ‘bid’ market could also apply to this solution. The disclosed solution herein also accommodates the fact that vehicle owners will remove their vehicles from the ‘emergency’ grid at their discretion. (And, as such, underscores the importance of the self-annealing nature of the grid-of-μGs).

This V2G power is enough to power not only the largest load on each node, such as a co-located 5G Small MIMO system, but also all other loads on a node, as well as similar nodes up and down the circuit, which may not have an EVSE or participating vehicle on the node.

The first step, unless creating sub-optimally defined a-priori cliques (AMI option 4, above), is to identify those nodes that will be able to become power nodes in the cliques. Given that all of these operations are occurring during a TBD emergency event, possibly to include local physical catastrophe, Built-In-Test (BIT) of any critical components (particularly any that could cause harm to otherwise viable components) is necessary before assuming that any device is ‘available’ for the functional recast into the grid-of-μGs. Under the presumption that the EVSE is viable, and that the AMI-derived switchgear has isolated the node (and payloads) appropriately and remains viable for additional commanded control, and there is a properly-responding and participating EV present with sufficient available power, then we know that a clique can form around that node. BIT check of the functional comms/sensor/effector payloads on the same node would place these local assets into the ‘available if needed’ hopper. This is only one of many possible assets to be so-energized.

Before continuing this accounting of determining how to identify which powered nodes should energize which assets to give an area-wide coverage of the best possible functional resources, a quick step into the nature of this type of ‘assignment’ problems.

Even if the resources (viable power, comms, and sensor/effector payloads) were known to a central controller, this is a nondeterministic polynomial (NP)-complete and NP-hard problem. Any NP-complete problem is compute intensive. Every permutation needs to be assessed before the best answer can be known, and it is even difficult to identify how good a given solution is even when given the best response (i.e., proofs are similarly compute-intensive). In most real-world approaches to solutions in this space, an algorithmic approximation of the complete analysis is all that can be achieved without significant computing resources and available time. Attempting to solve, as needs to be done for the grid-of-μGs state space, for a fast, area-wide configuration in a distributed collaboration, limited local computing, unknown-and-changing set of resources state space is a required component of the grid-of-μGs solution.

As each payload option is added to the problem space, the number of solutions increases by both an exponent that expresses not just that new resource, but the square of the number of such variables in the exponent, in which the ‘order matters’ interplay of all such options is expressed. Of the 21 accepted base forms of NP-complete problems, this is most similar to the ‘clique’ affinity problem common in social sciences and (more recently) commercial media modelling of influence and, interestingly, in the telecommunications domain in both determining where cell towers should be placed and, even once placed relatively optimally, how to make moving client assignments to those cell towers, expressed as having O(n^{k} k²) options.

Algorithmic simplification of the state space is typically done by iterative passes that build a ‘tension’ factor that can identify option sets that have collected undesirable and seemingly excluding weightings in the early passes of those many iterations. The grid-of-μGs state space is complicated by additional polynomials per viability of the nodes, multiple useful clique sizes, viability of the sensor/effector/comms payloads, and neighbor state (power source/propagation, or clique boundaries), differing amounts and durations of available power, and even the possibility that certain sensors or effectors may be more useful to a given emergency (if that can even be defined as a polynomial against possible emergency types), but these same parameters can be used in these ‘early pass’ weighted constraints simplifications.

Under the assumption that the energized configuration of the nodes/cliques/functions is, even in the presence of some electrical sensing and communications-supported collaboration, finally going to be calculated and ‘accepted’ for implementation locally by each powered and viable node (as opposed to attaining a many-node, many-clique-passes, solution), it is certain to be sub-optimal upon initial formation. But, the grid-of-μGs WILL form.

An average EV at an average State of Charge (SOC) can power the on-Grid load profile of a fully operational payload for 4-6 hours, and increases each year as the average range of EVs (i.e., EV battery energy capacity) increases. In emergency modes, this period can be more than doubled by mode-specific functions, dominantly as 5G beamforming and subscriber management, but power must continue to be managed dynamically; market and personal owner-configured use factors will influence which EVs will participate and for how long. During the initial grid-of-μGs configuration, an assumed period (e.g., a set number of minutes) of clique operation will be used to set a lower limit on the formation vs. reformation of the initial configuration, should a power node become unpowered due to operator removal of the EV. This yields an assumed EV energy available for the initial configuration, and allows a later transition to the dynamics of grid maintenance, which will differ from initial configuration. While market influences will tend to cause EV owners to stay ‘attached’, the nature of the emergency (and therefore need for the vehicle, or desire for a more fully-charged vehicle) could be a counterpoint to this. Similarly, ongoing disaster impacts, or the normal Grid system restoration (local or overall) are uncontrollable perturbations to any assumed stability. This said, it would seem reasonable to believe that the initial configuration will hold, for the most part, for 10 minutes or longer, transitioning to a more fully centralized solution, upon which communications to all operational nodes is established, and for which all cliques are known. Even in the absence of such centralized coordination, the initial collaborative configuration can be continued to accommodate for the presence/loss of power, communications, or payload resources, but less optimally. Should that central coordination be delayed or missing altogether, the grid-of-μGs is still area-wide, is still performing emergency-specific allocations (including unique mode commands for those in-clique systems), and still self-annealing.

With regard to these subsequent ‘improvements’, each such rearrangement causes an interruption of services, and potential for asset loss.

The same analysis may, when modelled against various disaster scenarios, also show where additional prophylactic hardening of critical infrastructure is warranted.

Upon Grid outage, and a let-the-Grid-fix-itself delay of TBD time (as addressed above, but between 3 cycles and 2 minutes, depending on the then-year criticality of uninterrupted 5G-serviced loads), the entire node network would isolate per the scheme (1-7, preference 3) selected above. Those nodes with EVSEs would, upon success of BIT, fully isolate the node in case 3, further isolating the distal circuit (for convention, U=Grid side, D=Distal side). All on-node loads would also be isolated from the EVSE, preparing the EVSE for transition to microgrid mode.

NOTE: BIT checks of those loads would also begin. In the self-test world, there is a differentiation of continuous BIT (CBIT) and instructed BIT (IBIT), and the tests performed under each can differ. Keeping in mind that the grid-of-μGs solution is intended to apply across a spectrum of Grid outages, to include significant widespread physical destruction of municipal and commercial assets, IBIT is presumed here. But, the system will work with no BIT at all. A determination of what tests are performed on what assets (power, comms, sensors/effectors) is somewhat independent of the disclosed solution, and that determination is not pursued here. This said, sensitivity of the forming μG to circuit issues or payload power irregularities should be a part of this consideration, and certainly a part of the system protection design.

Once the EVSE node is isolated (from the Grid and other on-node loads), the subset of these nodes that have a ‘subscribing’ EV present, electrically viable and with a suitable SOC, will transition to local voltage/frequency mode, and the EVSE (and/or EV) assumes responsibility for ongoing power distribution, power quality management, and, along with the AMI meter, remaining actions to establish the larger (a) local μG and (b) coordination to establish the grid-of-μGs. At this point, there are a number of power nodes (see prior definition, hereafter as PN) present in the affected area. Similar to the discussion above about the un-metered pass-through circuit (i.e., under each pole), the forming microgrid must be aware of the power it has available vs. the total power requirement of loads to be energized. The local microgrid-forming function ‘knows’ how many other poles and payloads can be energized as this calculation, based on the completed evaluation of its own load, and the a-prior knowledge of worst case of proximal nodes. Similarly, the microgrids must be able to ‘find’ their boundaries (independent of that power limit) beyond the single not-Grid-energized-but-with-available-V2G-source core pole of each node, which is done by sensing for the presence of power distal to the forming circuit (done at each ‘Grid and differentially’ capable meter, as noted above) and which it initially, is either Grid vs. other-microgrid power (i.e., it's just ‘don't-expand-in-that-direction’ power).

The first action of these PNs is to activate, if present, the on-node (but intended for off-board connection) communication payloads available to the PN. This is likely to be a 5G Small LTE system, but could include other RF (e.g., WiMAX) subsystems of local payloads. Note that the on-PN AMI RF mesh nodes would also be active at this point (TBD number per PN, as above), although the number of such active AMI payloads throughout the area may preclude their viability with regard to backhaul connectivity. Also note that, for purposes of establishing the grid-of-μGs, 5G connectivity is presumed to be used. Any other payload connectivity would only serve to re-establish the ‘normal’ function of that payload, which may or may not be possible, given the overall state of the outage/disaster. Activation of these secondary networks is not required for the grid-of-μGs, but since their power consumption is extremely low, and value to emergency operations may be high, activating them at this point seems prudent. And, if a backup for the grid-of-μGs is desired, it is possible that some more limited area-wide, emergency-specific, utilization of these other RF channels would be possible. That is not pursued further in this ‘baseline’ grid-of-μGs solution description.

Also note that it is possible that, for those 5G payloads with fiber connectivity (normally the case for nodes with 5G), connectivity may be functional, whereas LTE connectivity is not. How to use this abnormal configuration is left to the telecom providers, in that both signals are, at this point, known to their routing networks. Also note that it is presumed that the grid-of-μGs is established in a manner that can treat a 5G payload from any of the local service providers effectively independently of unique treatment by that service provider. That is, the grid-of-μGs is formed from all available assets without regard to which commercial group owns a given asset. Each telecom group would have to enable this ‘vanilla’ set of interoperability standards, which is only a slight twist on existing roaming handshake. This does not preclude each group from collecting revenue, during grid-of-μG operations, on its particular assets (e.g., a service provider whose system is more resilient should be compensated for that superior performance), or performing other market functions (not to interfere with emergency functions), but it is assumed that these are back office transactions not of relevance to the solution as described here.

From the vantage point of the power-capable node, there is a surrounding number of unknown payload assets (comms, or sensor/effectors), and semi-competing, but to-be-collaborated with PNs. Even if all circuits are physically intact (and they may not be), some of the comms and sensor/effector units in an ‘area of interest’ could possibly not be elements of the to-be-formed clique (i.e., μG) (e.g., there is no possible circuit connection); even though they may be potentially functionally overlapping with devices on the PN or other nodes available to the PN. That is, they are not on a circuit that can be ‘reached’ by the PN, whether that is due to normal circuit topologies or severed lines. In actuality, even if an a-prioiri ‘map’ of neighbors (at circuit and functional levels) is available, each node will have, during an emergency-initiated situation, an unknown set of functional payloads around it.

Each node is on a linear circuit, so these ‘additional’ functionally overlapping assets, all of them to be organized by the grid-of-μGs, are not under the power sharing, nor configuration control, of this PN. Actions to perform both the local and area-wide collaborative assignment of power and functionality follow.

Still in the first phase of forming the emergency grid (forming the power circuits (μGs)) each PN must successfully energize, and confirm as active, a 5G payload. As described above, this is first attempted if there is an on-PN 5G payload. If not, the μG ‘creeps’ (using the AMI CT sensors and switchgear) along the distal side to the next node. (The rationale for this distal traversal was addressed earlier, and serves, among other things, to accelerate the re-formation of a grid by avoiding collisions with other in-progress μG ‘explorations’ by other PNs).

If reporting properly through BIT, and now that the distal node AMI is energized, any distal 5G can be added to the PN-enabled μG. If no 5G is present/viable, it continues expanding the μG distally, along that linear circuit. Other payloads along this exploratory traversal are not energized (under the assumption of AMI switchgear cases (1) or (2), above). Although each load that is not energized is small, the cumulative number of payloads along this traversal could impact the PN. Furthermore, there is an increasing possibility of circuit or power-perturbing payload damage in those payloads that could compromise the integrity of the and these payloads are not fundamental to establishing a PN with 5G capability, even if that 5G is resident on another node. Effectively, if there is no 5G present on a distal node, the AMI conducts a ‘pass though’ of that distal node.

That similar payloads were energized on the PN itself could be challenged, as they are not fundamental to the grid-of-μGs. However, it seems useful to activate these on the PN itself, given the viability of other on-PN payloads and possible immediate interaction of those payloads with emergency response systems that may be operational in advance of establishing the grid-of-μGs.

It is presumed here that as soon as the μG has an active 5G cell, the μG power propagation ceases. Specific 5G vs. EVSE placement topologies may dictate that the ‘search’ for additional 5G nodes would continue, noting that their cumulative load on the EVSE V2G is such that adding a second 5G node comes close to halving the amount of time that both will be operational (unless additional energy is brought to bear). It is also possible that the functions assigned to a 5G node on circuit of higher node and payload counts would be assigned more limited functional (and power) roles in the overall grid-of-microgrids, as is possible with the diversity of configurations and functions available to AESA small MIMO antennae.

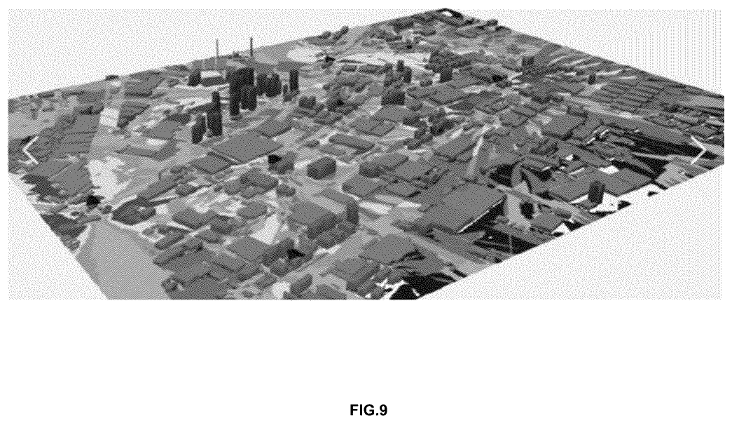

At this point, and assuming that all such 5G cells in the affected area are now active, an awkward anomalous variant of the more typical NP-complete cell tower placement and client assignment problem exists. Instead of iterating to achieve maximal coverage and expected (but location-varied) client densities (see FIG. 9 in which a context for implementing the present disclosure is illustrated), the set of assets known to be available is now fixed. That is, it would appear that some sub-optimal placement of 5G antennae has been established (i.e., is just one intermediate proposed solution to the area analysis), and it is what will now be expected to operate. But, this is not the grid-of-μGs end state. Herein, FIG. 9 illustrates a standard telecom base case, prior to performing the emergency/COOP overlay. That base case can be generated by a host of computers in advance of the deployment/build-out, not an ad-hoc reorganization of the assets.

Each active 5G node is expected to perform in emergency-specific manners, as outlined below. This functionality will be specifically within the purview of the telecom agents to develop, but is described here.

As addressed earlier, the functionality of the AESA antennae and associated processing as used in 5G LTE networks is much more capable and flexible than their predecessor large 4G AESA towers and base stations (although those did have line of sight and frequency propagation advantages). In many regards, every one of the 10s of thousands of 5G LTE stations in a metroplex is a base station. And, the following functions can be applied to the to-be-formed area-wide network: (1) Unlike their normal functions, a managed (vs. ad-hoc) mesh network can be established. Some antennae can be assigned to repeater functions, some to base station functions, and others remain as client endpoints. (2) All but emergency-authorized clients can be excluded. (3) Range can be modified, via mechanisms such as tolerated signal to noise ratios, type of beamforming/steering conducted by the array per a more limited number of clients, or even the awareness that a given ‘channel’ assignment is to a fixed location in the network (per ‘mesh’ comments, above). (4) Power consumption can be curtailed, solely by constraining bandwidth, but through other mechanisms at both the antenna and processing unit (more dominantly at the antenna). (5) In advance of establishing the expected grid-of-μGs area coverage, a true mesh (nearest neighbor) Ping can be used to identify for central planning all of the antennae available for assignment. This can even be done in a sequence of range-extended directed beams, either throughout a reasonable az/el surround, or per advance knowledge of where all possible receivers are located. Timing of these inter-node functions during the parallel activation of μGs would require some coordination or intermittent polling.

Given that the telecom algorithms are now ‘provided’ a set of available assets, the area-wide assignments can be performed, with the while-forming network able to provide specific configuration instructions to each node.

It is also possible that two stages of area-wide 5G activation would happen should this centrally coordinated instruction not be forthcoming.

The first is to establish and then use the nearest neighbor mesh connections to conduct a distributed solution, the intent being not to just create an ad-hoc mesh, but to minimize functional overlap, make assignments of repeaters and base stations, or react (via the aforementioned distributed network configuration) to required signal density. The second ‘fallback’ would be to have an emergency-specific mesh mode.

Note that there is an entire body of network computing and control systems theory that involves how to perform, under conditions of limited communications and no central processing, system optimization functions. Functional approaches from IEEE 1516 (Standard for Modelling & Simulation: High Level Architecture) are applicable, as are RF-specific solutions such as IEEE 802.11s (mesh networking), but these are just examples of the many such approaches.

The presumption here is that the telecom system would build to both a presumed centrally-solved solution and have a distributed (i.e., local, with minimal neighbor coordination) fallback. In either case, there is still one more set of operations left to be described with regard to the grid-of-μGs solution that can be conducted to optimize RF area coverage prior to declaring the 5G network stable and ‘as good as possible with the given assets’. This involves calling on the PNs for additional 5G assets.

Earlier, it was assumed that given μG formation is concluded when a PN and active 5G cell were paired, and that these operations were happening across all PNs in parallel. There could, however, be additional non-energized 5G nodes, whether on the U or D side of a PN, that can be added to each μG. Although seemingly power-prohibitive, both the centrally-mediated and distributed network configuration solutions can determine where it is worth reducing the expected operational (i.e., powered) period of any given node in deference to needed functionality. A ‘do this always’ version of such distributed processing would be the case of a single PN/5G μG that, upon Ping (a mode-unique Ping, not ICMP Standard Ping), did not ‘find’ a neighbor. It would continue propagating power, first D, but then U, in an attempt to add another 5G antenna. A ‘do this most of the time’ version would be the case where there was no 5G distal to a participating EVSE, responses to which could include joining as a paralleling power source to an already-formed upstream or receiving a handoff of a 5G node from such an upstream PN, with ‘coordination/instruction’ to form its own μG independently. Variations might even include dropping, at some point, one or more of the more proximal antennae that had been activated by a PN. A single PN would only be able to support the power requirement of perhaps 3-5 antennae (likely more, or for longer, once in their final grid-of-μGs configuration), but one of those could be the 10^{th} least proximal to than PN. Given that the Ping function is working in an range-enhanced and cross-Provider-asset nonstandard mode, it should not be assumed that the normal spacing of antennae has a lot to do with the emergency spacing. Even normal S/N requirements could be relaxed in an emergency setting, benefiting both power consumption and coverage goals.

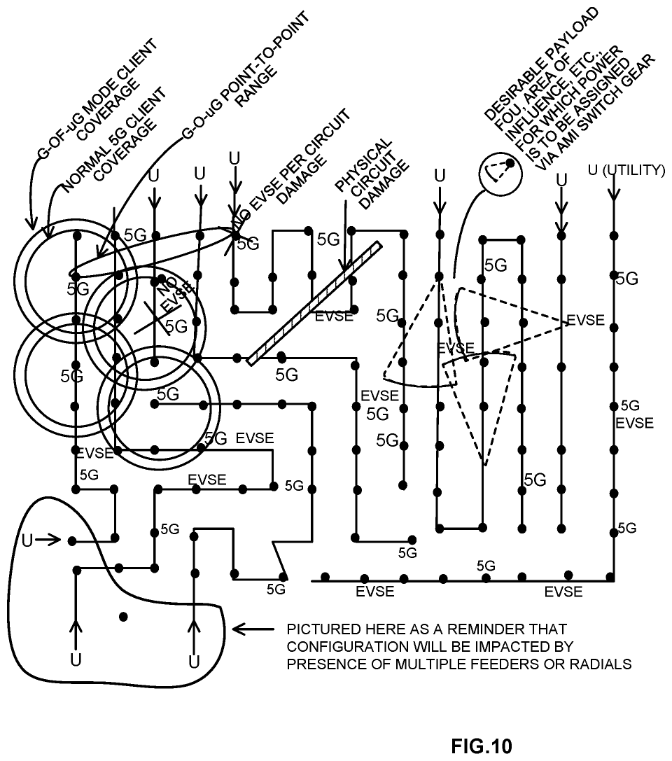

FIG. 10 illustrates a diagram of an example grid-of-μGs in accordance with one example embodiment. The diagram is not intended to be per physical circuit layouts, and is only generally spatially accurate so as to show the interaction between 5G or other payload coverage between circuits, as well as emergency-mode-specific allocations of functionality to achieve area coverage. In the upper middle area, for example, the lack of powered 5G in that 1×5+ grid area would require that neighboring cells be put into unusual (even for the grid-of-μGs mode) range modes, or would require other actions to provide coverage in that area, even possibly as increased first responder (vs. IoT-enabled) coverage. It's also quite possible that the neighboring but not pictured assets above this area would provide this coverage.

In FIG. 10, every node is a pole on the utility circuit and public right of way. Almost all have streetlights (80′-100′ apart) but some 5G-only poles do exist. In some cases the ‘U’ (utility) ends two or more otherwise linear circuits could be connected in a single but that case is not pictured here. Network recomposition during grid-of-microgrid operations can use mode-specific range enhancements to first establish best coverage and then perform a sensors/effectors best-fit, given that neither is specific to the ug power circuits themselves.

Indeed, if it is assumed that this is a 100′ grid (per streetlights), then even NORMAL coverage by 5G would be in excess of 500′ (if not obstructed) in this urban setting, with emergency mode coverage at significantly more than twice that range. That is, although the diagram was intended to be addressing only the nature of assets and their reassignment, there likely would not be any coverage gaps in the grid-of-μGs as formed in that illustration of FIG. 10, even in the first pass.

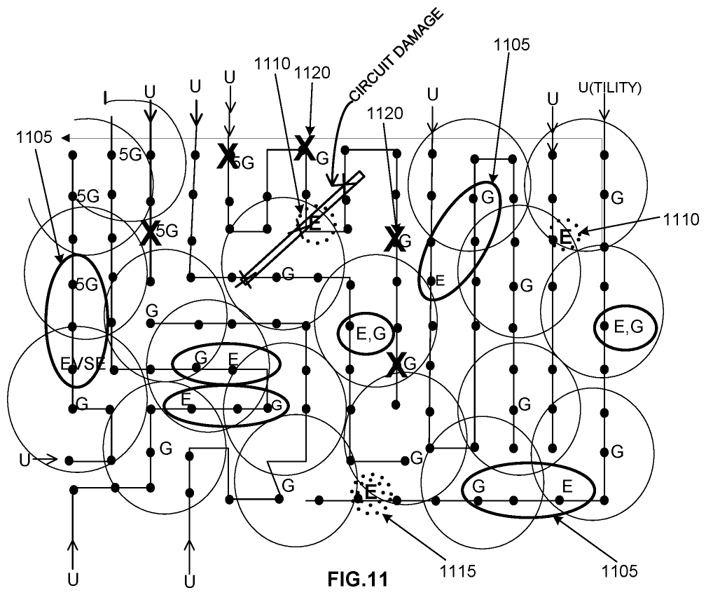

FIG. 11 illustrates a diagram of another example grid-of-μGs in accordance with one example embodiment. FIG. 11 shows the first pass, distal only, single 5G (‘G’) μG formation by assuming that all EVSEs have participating EVs. Only one of the powered nodes without 5G is subject to accepting an ‘upstream’ 5G, per collaborative assignment. Very few 5G nodes could not be energized if needed and areas of high overlap would be repeater/base candidates.

In FIG. 11, it is assumed that all EVSEs have participating EVs. The first pass, distal only, single 5G(‘G’) μG formation is as follows circles 1105. Powered nodes without 5G are indicated as 1110, only one of which is subject to accepting an ‘upstream’ 5G, per collaborative assignment as indicated by 1115. Very few 5G nodes could not be energized if needed. Areas of high overlap as indicated by 1120 would be repeater/base candidates.

This same iterative improvement would be the mechanism by which continued ‘insults or opportunities’ to the already-established grid-of-μGs would be accommodated.

Upon establishing the best possible (and changing, as necessary) power and RF configurations, there is still the task of activating the other node payloads and doing so appropriately to the emergency need.

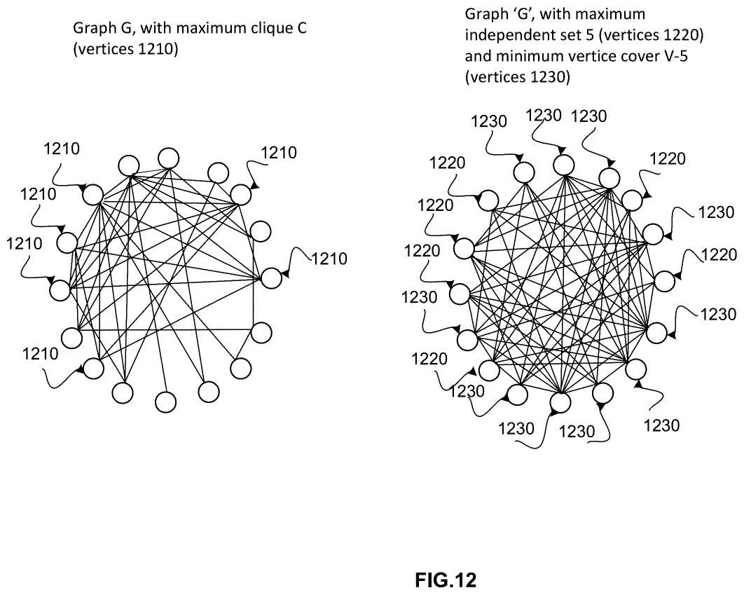

Powered, and variably powered, connectivity and function of the payloads is then assessed. FIG. 12 shows diagrams of example connectivity of payloads in accordance with one example embodiment. The various effective multispectral and audio spheres of influence of the to-be-energized/moded payloads (not all as literal spheres) are evaluated as an inverse squared (when AESA-formed) or inverse cubed (if broadcast) areal connectivity assessment, with similar functional payload estimations (in coordination with other forming circuits/payloads), observing emergency priorities and mode-specific cyber concerns. This power, circuit, communications, and payload optimization would be a tough NP-complete problem with centralized computing; exercising a fast, distributed solution will be challenging. A mix of edge computing and system state estimation with minimal state coupling allows for improved solutions; the unknown amount of central processing (AMI and once networked) both enhances and complicates the problem space. These functions will collectively address the local processing for 10s or even 100s of thousands of nodes (e.g., there are 100,000 streetlights in just Dallas, at similar densities to the expected 5G Ultra WideBand (UWB) build-out). The 5G UWB can be equated with the higher frequency, lower latency, 5G small MIMO system. Configuration needs to be automated, and reactive as energy is depleted or priorities change (e.g., prolonged outages, dropped/recovered assets).

Even in the presence of TBD central coordination/processing, the number of assets and potential configuration options, and the fact that human operators will be better utilized if dealing with known problems vs. infrastructure concerns, dictates that this complexity be addressed in an automated manner. That said, the entire network is available for human intervention, at a per-payload level (per the PN/cell/AMI identity of each payload), as time permits or the situation demands.

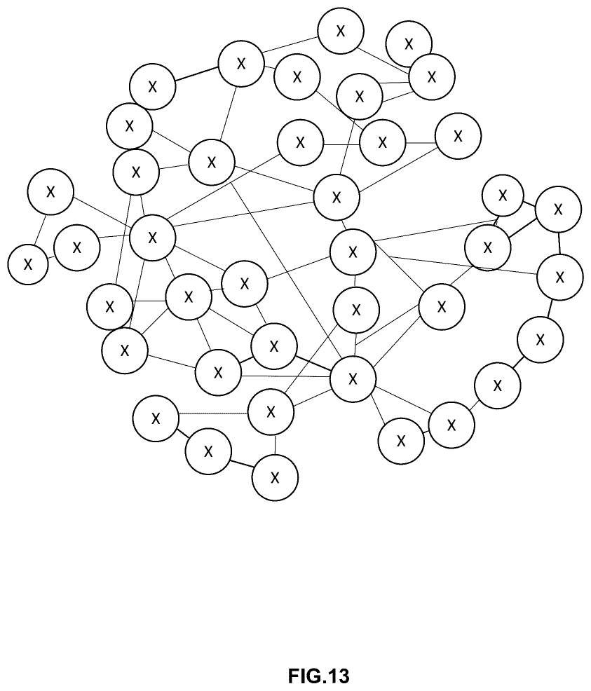

As described, the present disclosure provides methods and systems for restoration of essential systems per catastrophic Utility emergency. An automated and ubiquitous ‘backup Grid’ for delivery of emergency communications, sensing, and public services (e.g., future smart vehicles/highways and other IoT services) is achievable with otherwise-deployed (i.e., on-Grid) and available assets after Grid failure. Formed automatically with energy from participating ‘public charging’ electric vehicles (EVs), a number of coordinating but electrically isolated microgrids (μGs) can energize co-located or proximal sensor/effector assets, and provide an IoT gateway for other operational but off-board assets. FIG. 13 shows a diagram of an example grid-of-μGs formed on an Utility power Distribution network, in accordance with one exemplary embodiment.

During prolonged outages, this grid-of-μGs also allows dynamic power and payload management for public-inclusive Continuity of Operations (COOP). Organizing this grid-of-μGs is an NP-complete variant of the graph theory clique problem O(n^{k2}), complicated by additional polynomials per viability of the nodes, multiple useful clique sizes, viability of the sensor/effector/comms payloads, and neighbor state (power source/propagation, or clique boundaries). Configuration of the nodes/cliques/functions is calculated locally by each powered and viable node, and is certain to be sub-optimal upon initial formation but the grid-of-μGs will form, subject to further optimized or dynamic control, noting that each such rearrangement causes an interruption of services, and potential for asset loss. Algorithms to address the initially local and subsequently centralized NP-hard control/participation are central to the disclosed investigation, but improvement via emerging computing architectures also evolving over this timeframe will be proposed. The same analysis may also show where additional prophylactic hardening of critical infrastructure is warranted. That is, although the disclosed solution is based on the re-allocation of normally operational systems, this does not preclude the placement of such normally-operational system in a manner that is more resilient to possible systemwide failure.

Everywhere that there are streetlights and EVs, effectively ‘everywhere’ by 2030, a set of self-healing technology-enabling platforms can form a network of small μGs and associated critical infrastructure for event-defined areas of need, addressing in an ad-hoc but cooperative fashion their own availability, the scope of the specific services interruption, and the nature of the emergency, also coordinating, when available, with municipal and Utility progress, or worsening conditions, with regard to the restoration of services. The disclosed system-of-systems solution assumes that this ‘emergency mode’ market is operated across otherwise competing commercial assets, but must comprehend platform ‘payload’ off-Grid markets and also impacts to the on-Grid ‘normal’ operations, the latter of which make this intermittent resilience mode economically viable (e.g., upcoming rollouts of millions of 5G Ultra-Wide Band (5G UWB) antennas, vehicle on-Grid charging and Vehicle-to-Grid (V2G) functions, automated metering as switchgear and other electrical Distribution Management Systems, blockchain, smart cities infrastructure, etc.). Note that the disclosed solution provides social and environmental equity components that, although not central to the disclosure, bring additional merit: a higher number of urban underserved/multi-family opportunities for participation (streetlights, community services, and valuation of publicly-charging EVs), an assumed efficiency of aggregate system resilience, and also the merit of the solution to even one such node in a small rural community. The flexible power/range/function configuration of an emergency-configured Active Electronically Scanned Array (AESA) 5G UWB antenna is also unique to the disclosed solution.

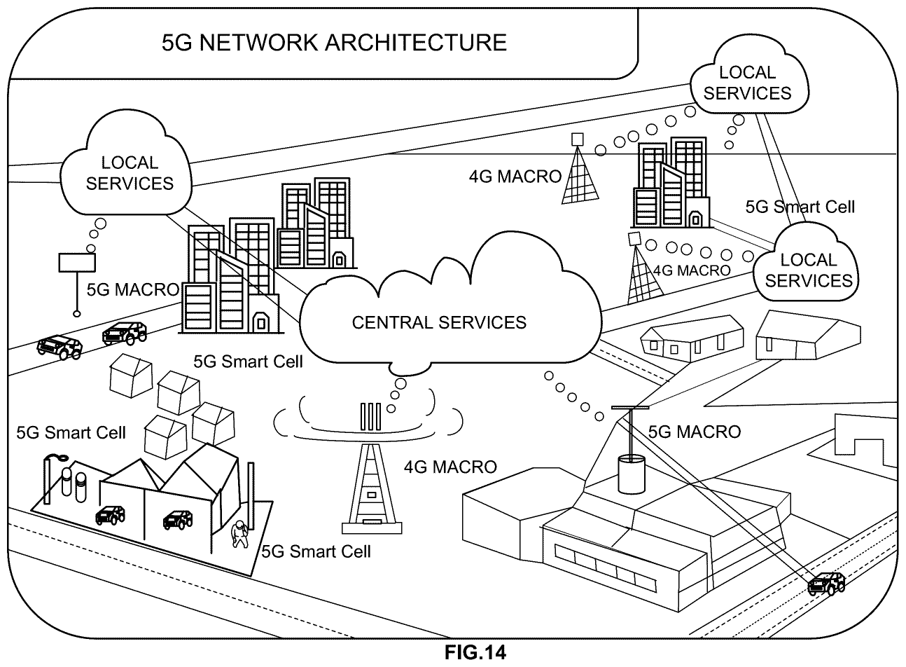

It is important to understand the environment in which the disclosed system would be valued. By 2030, a typical city landscape will require/include: (1) A majority of new vehicles will be all-electric, approaching a majority-electric transportation system. A third of the country's energy is associated with transportation, as vehicle and fuel manufacturing/distribution/disposal, transit infrastructure, and the movement of people and goods. Energy system impacts from this transition from transportation powered via consumed fuel vs. released storage will be profound, and place a premium on Grid resilience. (2) Autonomous vehicles and intelligent highways will exist, dominantly in cities and on Interstates. Humans in many vehicles will be in control of only the destination, with transit time an extension of their increasingly electrified, personal, and interactive information bubble. Personal transit as a service will provide other energy efficiency opportunities. (3) 5G is fundamental to this transition, but is not 5G as we know it. An additional three orders of magnitude higher content via high frequency but lower range 5G UWB will be needed by sensors/effectors/IoT communications, requiring antennas every −500 feet in urban settings, at 4-5 kW each, and for each carrier (urban centers themselves also growing). This is a significant departure from the taller and omnidirectional base stations as deployed today. Some cities will be ‘smarter’ than others with regard to their use of multispectral imaging, RF, and audio tracking (e.g., gunshot or accident detection), and other integrated public payloads supporting traffic management, safety/emergency response, waste management, hazard detection, 311 access, event signaling, vehicle charging, reactive lighting, etc. Large metro areas will have become dependent on these services, particularly during emergencies. (4) Home/workplace delivery, information-intensive local products synthesis, and distance learning/remote workplace activity will reduce in-person public exchange while requiring additional information-intensive support. Cumulatively, these trends will amplify personal Grid-edge spaces. In their abodes and workplaces, this high bandwidth and extremely personalized set of data and effectors (not just as monitors, tablets, mice, etc.), will achieve a level of immediacy and customization in which the persona becomes that tailored medium. FIG. 14 illustrates a schematic diagram of an example smart city in accordance with one exemplary embodiment.

Disruptions to this assumed and largely ignored underlying communications and energy fabric, although fundamental to this future society, will change from today's level of ‘annoyance’ to, literally, tomorrow's gridlock. This will be at physical, commerce, and personal levels.

The systems and methods disclosed herein do more than provide resilience to certain payloads. It provides a mode-unique, arbitrary area-wide, highly plastic emergency ‘Grid’ and, as possible, additional public services. It forms under any set of viable assets. Although the future offers better batteries and fuel cells, more and cleaner Distributed Energy Resources (DER), 5G as 6G, and increased levels of at-home/at-business resilience, those local assets only reach out to the IoT-defined markets, computing servers, shared public spaces, and transportation-related object connectivity (even to the mundane securing of sustenance).

The applicable set of technology-enabling platforms (nodes of power, comms, and city infrastructure) will already be in place while on-Grid. Reorganizing these as an off-Grid and resilient set of μGs requires: (a) forming as-available power circuits and (b) functional ‘payload’ coverage the latter addressing both communications and the conveyance of information to/from payloads. The power infrastructure is the same as existing streetlights. Single phase and split phase power exists at some number of nodes on a common transformer (typically 4-12). The bidirectional DCFC V2G charger at these locations faces is still <200 A, allowing use of the Automated Meter Infrastructure (AMI ‘smart meters’) as circuit-isolating switchgear also better matching widespread urban deployment than would larger highway DC units. An average EV at an average SOC can power the on-Grid load profile for 4-6 hours. In emergency modes this period can be more than doubled by mode-specific functions dominantly as 5G beamforming and subscriber management, but power must continue to be managed dynamically, market and personal use factors will influence which EVs will participate and for how long. Forming the system and processes described by the present disclosure circuits can only be done where there is power first as the presence of these participating EVs, then as formation of local voltage/frequency/system protection circuits (i.e. μG ‘islanding’), then extending to critical resources on and beyond that powered node (using AMI at payload and node levels). To do so, payload integrity is assessed, and sectionalizing the overall radial is an exercise in local coordination with other forming uGs, potentially with central interaction by the central AMI that remains powered briefly during outages, or which may still be present for on-Grid assets in the area.

Powered, and variably powered, connectivity and function of the payloads is then assessed. The various effective multispectral and audio spheres of influence of the to-be-energized/moded payloads (not all as literal spheres) are evaluated as an inverse squared (when AESA-formed) or inverse cubed (if broadcast) areal connectivity assessment, with similar functional payload estimations (in coordination with other forming circuits/payloads) observing emergency priorities and mode-specific cyber concerns (e.g. a given UWB node may act only as a relay). This power, circuit, communications, and payload optimization would be a tough NP-complete problem with centralized computing; exercising a fast distributed solution will be challenging. A mix of edge computing and system state estimation with minimal state coupling allows for improved solutions; the unknown amount of central processing (AMI and once networked) both enhances and complicates the problem space.

In summary, the present disclosure provide systems and methods of forming an emergency response and Continuity of Operations (COOP) area-wide grid of microgrids. The method can comprise: upon an power outage occurring to an Utility power Distribution grid network, identifying one or more nodes having an electric vehicle service equipment (EVSE) power; forming a power microgrid comprising the one or more nodes; activating a communication payload on the one or more nodes; and forming an area-wide grid of microgrids based on the communication payload and the power microgrid.

In some embodiments, the EVSE is an EV direct current (DC) faster charger (DCFC) installed on the one or more nodes. In some embodiments, the one or more nodes are streetlight poles powered by the Utility power Distribution grid network. In some embodiments, the one or more nodes are identified by allocating a local backup battery of an Automated Metering Infrastructure (AMI) meter to identify the EVSE power. In some embodiments, the one or more nodes are identified by allocating a last gasp AMI meter capacitor to identify the EVSE power. In some embodiments, the EVSE power is provided by an EV attached to the EVSE, the EV supporting reverse power flow from vehicle to Grid (V2G) and having been previously marked by its owner as being available for bi-directional on-Grid or off-Grid services. In some embodiments, the one or more nodes are electrically isolated from the Utility power Distribution Grid network. In some embodiments, the one or more nodes are electrically isolated by an Automated Metering Infrastructure (AMI) meter that acts as an AMI-derived switchgear and is located between the one or more nodes and the Utility power Distribution Grid network.

In some embodiments, the method can further comprise electrically isolating from the EVSE the communication payload and other payloads associated with the one or more nodes. In some embodiments, an AMI is configured to electrically isolate from the EVSE the communication payload and other payloads associated with the one or more nodes. In some embodiments, the method can further comprise performing Built-In-Test (BIT) of the communication payload and other payloads associated with the one or more nodes. In some embodiments, the BIT is a continuous BIT or an instructed BIT. In some embodiments, the one or more nodes are configured to have one or more other payloads installed on at least one of the one or more nodes. In some embodiments, the one or more other payload comprise one or more of a lighting unit, a sensor, or an effector. In some embodiments, the communication payload is a 5G payload.

In some embodiments, the method can further comprise transitioning the one or more nodes to a local voltage and frequency mode corresponding to the EVSE power. In some embodiments, the communication payload performs one of a repeater function, a base station function, or a client endpoint function. In some embodiments, the method can further comprise activating other payloads associated with the one or more nodes. In some embodiments, the method can further comprise assessing connectivity and function of the other payloads. In some embodiments, the method can further comprise optimizing the area-wide grid of microgrids.

Throughout the specification and the claims, the following terms take at least the meanings explicitly associated herein, unless the context clearly dictates otherwise. The term “or” is intended to mean an inclusive “or.” Further, the terms “a,” “an,” and “the” are intended to mean one or more unless specified otherwise or clear from the context to be directed to a singular form.

In this description, numerous specific details have been set forth. It is to be understood, however, that implementations of the disclosed technology may be practiced without these specific details. In other instances, well-known methods, structures and techniques have not been shown in detail in order not to obscure an understanding of this description. References to “some examples,” “other examples,” “one example,” “an example,” “various examples,” “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrases “in one example,” “in one embodiment,” or “in one implementation” does not necessarily refer to the same example, embodiment, or implementation, although it may.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

While certain implementations of the disclosed technology have been described in connection with what is presently considered to be the most practical and various implementations, it is to be understood that the disclosed technology is not to be limited to the disclosed implementations, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed technology, including the best mode, and also to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method of forming an emergency response and continuity of operations (COOP) area-wide grid of microgrids, comprising:
upon an power outage occurring to an Utility power distribution grid network, identifying one or more nodes having an electric vehicle service equipment (EVSE) power;
forming a power microgrid comprising the one or more nodes;
activating a communication payload on the one or more nodes; and
forming an area-wide grid of microgrids based on the communication payload and the power microgrid.

2. The method of claim 1, wherein the EVSE is an EV 120V or 240V AC-coupled direct current (DC) faster charger (DCFC) installed on the one or more nodes.

3. The method of claim 1, where the one or more nodes are streetlight poles powered by the Utility power distribution grid network.

4. The method of claim 1, wherein the one or more nodes are identified by allocating a local backup battery of an automated metering infrastructure (AMI) meter to identify the EVSE power.

5. The method of claim 1, wherein the one or more nodes are identified by allocating a last gasp AMI meter capacitor to identify the presence and necessary isolation of available EVSE power.

6. The method of claim 1, wherein the EVSE power is provided by an EV attached to the EVSE, the EV supporting reverse power flow from Vehicle to Grid (V2G) and having been previously marked by its owner as being available for bi-directional on-Grid or off-Grid services.

7. The method of claim 1, wherein the one or more nodes are electrically isolated from the Utility power distribution grid network.

8. The method of claim 1, wherein the one or more nodes are electrically isolated by an automated metering infrastructure (AMI) meter that acts as an AMI-derived switchgear and is located between the one or more nodes and the Utility power distribution grid network.

9. The method of claim 1, further comprising electrically isolating from the EVSE the communication payload and other payloads associated with the one or more nodes.

10. The method of claim 9, wherein an AMI is configured to electrically isolate from the EVSE the communication payload and other payloads associated with the one or more nodes.

11. The method of claim 1, further comprising performing Built-In-Test (BIT) of the communication payload and other payloads associated with the one or more nodes.

12. The method of claim 1, wherein the BIT is a continuous BIT or an instructed BIT.

13. The method of claim 1, wherein the one or more nodes are configured to have one or more other payloads installed on at least one of the one or more nodes.

14. The method of claim 1, wherein the one or more other payload comprise one or more of a lighting unit, a sensor, or an effector.

15. The method of claim 1, wherein the communication payload is a 5G payload.

16. The method of claim 1, further comprising transitioning the one or more nodes to a local voltage and frequency mode corresponding to the EVSE power.

17. The method of claim 1, wherein the communication payload performs one or more of a repeater function, a base station function, or a client endpoint function.

18. The method of claim 1, further comprising activating other payloads associated with the one or more nodes.

19. The method of claim 18, further comprising assessing connectivity and function of the other payloads.

20. The method of claim 1, further comprising optimizing the area-wide grid of microgrids.
